(19) United States
(12) Patent Application Publication
(10) Pub. No.: US 2026/0219502 A1
(43) Pub. Date: Jul. 30, 2026

(54) EYEPIECE OPTICAL SYSTEM, WIDE-FIELD IMAGE DISPLAY DEVICE

(71) Applicant: KOPIN CORPORATION, WESTBOROUGH, MA (US)

(72) Inventor: YOICHI IBA, HACHIOJI (JP)

(73) Assignee: KOPIN CORPORATION, WESTBOROUGH, MA (US)

(21) Appl. No.: 19/142,794

(22) PCT Filed: Dec. 28, 2023
(86) PCT No.: PCT/JP2023/047231

§ 371 Date: Jun. 24, 2025

(30) Foreign Application Priority Data
Dec. 28, 2022 (JP) 2022-212636

(51) Int. Cl. G02B 27/01; G02B 1/04; G02B 7/02; G02B 13/18; G02B 15/14; G02B 25/00; G02B 27/28

(52) U.S. Cl. CPC G02B 27/0172; G02B 1/041; G02B 7/021; G02B 13/18; G02B 15/143105; G02B 25/001; G02B 27/283; G02B 2027/0123; G02B 2027/0156; G02B 2027/0178

(57) ABSTRACT

To provide an eyepiece optical system, etc., that suppresses the occurrence of flare, ghosting, and chromatic aberration. An eyepiece optical system of a wide-field image display device includes in order from the eye point EP side, a first lens L1 with a convex surface facing the image display element DP side and positive refractive power, a second lens L2 with a concave surface facing the image display element DP side, and a third lens L3 with a convex surface facing the eye point EP side, with a first film F1 adhered to the eye point EP side surface of the second lens L2, which changes the light traveling towards the eye point EP side to the first polarization state, a second film F2 adhered to the eye point EP side surface of the first lens L1, which reflects light in the first polarization state traveling towards the eye point EP side and changes it to the second polarization state, and transmits light in the second polarization state traveling towards the eye point EP side, and a half mirror HM coated on the image display element DP side surface of the first lens L1, satisfying predetermined conditional expressions.

### TECHNICAL FIELD

The present invention relates to an eyepiece optical system with a field of view angle of 80 degrees or more, and a wide-field image display device.

### BACKGROUND ART

Conventionally, eyepiece optical systems used in wide-field image display devices such as HMDs (Head Mounted Displays) have been proposed (see, for example, Patent Documents 1 and 2).

### PRIOR ART DOCUMENTS

### Patent Documents

[Patent Document 1] JP 2022-88582 A. [Patent Document 2] WO 2022/038777.

Conventional eyepiece optical systems like those in Patent Document 1 have had the problem of being prone to flare and ghosting. Additionally, conventional eyepiece optical systems like those in Patent Document 2 have had the problem of significant chromatic aberration.

### SUMMARY OF THE INVENTION

Therefore, the present invention has been devised in view of the above problems, and has as an object to provide an eyepiece optical system and a wide-field image display device that suppress the occurrence of flare, ghosting, and chromatic aberration.

To solve the above problems, the present invention provides an eyepiece optical system disposed between an eye point of a wide-field image display device and an image display element, comprising
a first lens with a convex lens surface on the image display element side and positive refractive power, a second lens with a concave lens surface on the image display element side, and a third lens with a convex lens surface on the eye point side, arranged in order from the eye point side,
a first film which is adhered to the lens surface on the eye point side of the second lens and changes the polarization state of light traveling from the image display element side to the eye point side to a first polarization state, and
a second film which is adhered to the lens surface on the eye point side of the first lens, reflects light in the first polarization state traveling from the image display element side to the eye point side and changes said light to a second polarization state, and transmits light in the second polarization state traveling from the image display element side to the eye point side,
wherein a half mirror is coated on the lens surface on the image display element side of the first lens, and
the following conditional expressions are satisfied.

$$0.8 \times P 0 < ( 2 \times N 1 / L 1 e ) + ( 2 \times N 1 / L 1 r ) < 1.2 \times P 0$$

$$v 2 < v 3$$

where,
   P0: refractive power of the eyepiece optical system (unit: mm⁻¹)
   N1: refractive index of the first lens for light with a wavelength of 525 nm
   L1e: radius of curvature of the lens surface on the eye point side of the first lens (unit: mm)
   L1r: radius of curvature of the lens surface on the image display element side of the first lens (unit: mm)
   ν2: Abbe number for the d-line (wavelength 587.6 nm) of the second lens
   ν3: Abbe number for the d-line (wavelength 587.6 nm) of the third lens
Note that the radii of curvature L1e and L1r are positive for convex surfaces. Additionally, a concave surface is a surface where the edge of the lens protrudes beyond the center of the lens surface in the optical axis direction, and a convex surface is a surface where the center of the lens surface protrudes beyond the edge of the lens in the optical axis direction.

The present invention also provides a wide-field image display device characterized by being provided with the above eyepiece optical system.

### Effects of the Invention

According to the present invention, it is possible to provide an eyepiece optical system and a wide-field image display device that suppress the occurrence of flare, ghosting, and chromatic aberration.

### BRIEF DESCRIPTION OF THE DRAWINGS

FIG. 1 is a sectional view showing the configuration of a wide-field image display device equipped with the eyepiece optical system according to an embodiment of the present invention.

FIG. 2A is a perspective view showing the configuration of a wide-field image display device equipped with the eyepiece optical system according to an embodiment of the present invention, and FIG. 2B is a perspective view showing the configuration of the third lens of the eyepiece optical system.

FIG. 3A is a sectional view showing the state of moving the first lens in the optical axis direction with the eyepiece optical system equipped with a fourth lens according to an embodiment of the present invention, and FIG. 3B is a sectional view showing the state of removing the fourth lens from the eyepiece optical system.

FIG. 4 is a sectional view of embodiment 1 of the eyepiece optical system according to an embodiment of the present invention.

FIG. 5A is a diagram showing the relationship between focal shift and the absolute value of the Optical Transfer Function (OTF) in embodiment 1, and FIG. 5B is a spot diagram of embodiment 1.

FIG. 6A is a diagram showing the relationship between field curvature and field of view angle in embodiment 1, FIG. 6B is a diagram showing the relationship between percent distortion and field of view angle in embodiment 1, and FIG. 6C is a diagram showing the chromatic aberration of magnification in embodiment 1.

FIG. 7 is a sectional view of embodiment 2 of the eyepiece optical system according to an embodiment of the present invention.

FIG. 8A is a diagram showing the relationship between focal shift and the absolute value of the OTF in embodiment 2, and FIG. 8B is a spot diagram of embodiment 2.

FIG. 9A is a diagram showing the relationship between field curvature and field of view angle in embodiment 2, and FIG. 9B is a diagram showing the relationship between percent distortion and field of view angle in embodiment 2. FIG. 9C is a diagram showing the chromatic aberration of magnification in embodiment 2.

FIG. 10 is a sectional view of embodiment 3 of the eyepiece optical system according to an embodiment of the present invention.

FIG. 11A is a diagram showing the relationship between focal shift and the absolute value of the OTF in embodiment 3, and FIG. 11B is a spot diagram of embodiment 3.

FIG. 12A is a diagram showing the relationship between field curvature and field of view angle in embodiment 3, FIG. 12B is a diagram showing the relationship between percent distortion and field of view angle in embodiment 3, and FIG. 12C is a diagram showing the chromatic aberration of magnification in embodiment 3.

FIG. 13 is a sectional view of embodiment 4 of the eyepiece optical system according to an embodiment of the present invention.

FIG. 14A is a diagram showing the relationship between focal shift and the absolute value of the OTF in embodiment 4, and FIG. 14B is a spot diagram of embodiment 4.

FIG. 15A is a diagram showing the relationship between field curvature and field of view angle in embodiment 4, FIG. 15B is a diagram showing the relationship between percent distortion and field of view angle in embodiment 4, and FIG. 15C is a diagram showing the chromatic aberration of magnification in embodiment 4.

FIG. 16 is a sectional view of embodiment 5 of the eyepiece optical system according to an embodiment of the present invention.

FIG. 17A is a diagram showing the relationship between focal shift and the absolute value of the OTF in embodiment 5, and FIG. 17B is a spot diagram of embodiment 5.

FIG. 18A is a diagram showing the relationship between field curvature and field of view angle in embodiment 5, FIG. 18B is a diagram showing the relationship between percent distortion and field of view angle in embodiment 5, and FIG. 18C is a diagram showing the chromatic aberration of magnification in embodiment 5.

FIG. 19 is a sectional view of embodiment 6 of the eyepiece optical system according to an embodiment of the present invention.

FIG. 20A is a diagram showing the relationship between focal shift and the absolute value of the OTF in embodiment 6, and FIG. 20B is a spot diagram of embodiment 6.

FIG. 21A is a diagram showing the relationship between field curvature and field of view angle in embodiment 6, FIG. 21B is a diagram showing the relationship between percent distortion and field of view angle in embodiment 6, and FIG. 21C is a diagram showing the chromatic aberration of magnification in embodiment 6.

FIG. 22 is a sectional view of embodiment 7 of the eyepiece optical system according to an embodiment of the present invention.

FIG. 23A is a diagram showing the relationship between focal shift and the absolute value of the OTF in embodiment 7, and FIG. 23B is a spot diagram of embodiment 7.

FIG. 24A is a diagram showing the relationship between field curvature and field of view angle in embodiment 7, FIG. 24B is a diagram showing the relationship between percent distortion and field of view angle in embodiment 7, and FIG. 24C is a diagram showing the chromatic aberration of magnification in embodiment 7.

### DETAILED DESCRIPTION

An eyepiece optical system and the wide-field image display device according to an embodiment of the present invention will be described below. The eyepiece optical system according to this embodiment is an eyepiece optical system disposed between an eye point of a wide-field image display device and an image display element (display), comprising a first lens with a convex lens surface on the image display element side and positive refractive power (power), a second lens with a concave lens surface on the image display element side, and a third lens with a convex lens surface on the eye point side, arranged in order from the eye point side, a first film (polarization control film) which is adhered to the lens surface on the eye point side of the second lens and changes the polarization state of light traveling from the image display element side to the eye point side to a first polarization state, and a second film which is adhered to the lens surface on the eye point side of the first lens and reflects light in the first polarization state traveling from the image display element side to the eye point side and changes said light to a second polarization state, and transmits light in the second polarization state traveling from the image display element side to the eye point side, wherein a half mirror is coated on the lens surface on the image display element side of the first lens, and the following conditional expressions (1) and (2) are satisfied.

$$0.8 \times P 0 < ( 2 \times N 1 / L 1 e ) + ( 2 \times N 1 / L 1 r ) < 1.2 \times P 0 \qquad ( 1 )$$

$$v 2 < v 3 \qquad ( 2 )$$

where,
   P0: refractive power of the eyepiece optical system (unit: mm⁻¹)
   N1: refractive index of the first lens for light with a wavelength of 525 nm
   L1e: radius of curvature of the lens surface on the eye point side of the first lens (unit: mm)
   L1r: radius of curvature of the lens surface on the image display element side of the first lens (unit: mm)
   ν2: Abbe number for the d-line (wavelength 587.6 nm) of the second lens
   ν3: Abbe number for the d-line (wavelength 587.6 nm) of the third lens
Note that the radii of curvature L1e and L1r are positive for convex surfaces. Additionally, a concave surface is a surface where the edge of the lens protrudes beyond the center of the lens surface in the optical axis direction, and a convex surface is a surface where the center of the lens surface protrudes beyond the edge of the lens in the optical axis direction.

(Operation and Effects). This configuration allows for the realization of a so-called pancake optical system with reduced flare, ghosting, and chromatic aberration. Note that the “eye point” refers to the user's pupil. “Forward tracing” refers to the tracking of light rays traveling from the image display element towards the eye point, while “reverse tracing” refers to the tracking of light rays traveling from the eye point towards the image display element. A “concave surface” is a surface where the edge of the lens (the outer peripheral part of the region through which light passes) protrudes outward in the optical axis direction beyond the center (the part intersecting with the optical axis) of the lens. A “convex surface” is a surface where the center of the lens surface protrudes outward in the optical axis direction beyond the edge of the lens surface.

Many image display elements display red images, green images, and blue images, and by additive mixing, create images of various colors. If the eyepiece optical system has chromatic aberration of magnification, which is one type of chromatic aberration, the projection magnification of the image display element projected by the eyepiece optical system changes according to the wavelength, resulting in color misalignment of red, green, and blue in the projected image. However, this color misalignment can be electrically corrected through image signal processing. Specifically, by changing the size of the red images, green images, and blue images displayed on the image display element according to the chromatic aberration of magnification, a projected image without color misalignment can be created.

However, if the eyepiece optical system has chromatic aberration of magnification, the red light, green light, and blue light that create the red images, green images, and blue images will experience changes in magnification within the range of their respective spectral widths, resulting in radial blur in each of the red images, green images, and blue images. This radial blur cannot be electrically corrected. Therefore, to achieve high resolution in an eyepiece optical system that magnifies and projects the image of the image display element, it is necessary to reduce chromatic aberration.

The forward tracing of light rays in the eyepiece optical system of the present invention will be described. Light exiting the image display element and entering the second lens passes through the first film, becomes the first polarization state, and proceeds towards the first lens. The lens surface on the image display element side of the first lens is coated with a half mirror, so some light passes through the half mirror. The light then passes through the first lens and enters the second film. Since this light (LA1) is in the first polarization state, it is reflected by the second film and changed to the second polarization state. This light (LA2), now in the second polarization state, travels back through the first lens towards the half mirror coated on the image display element side of the first lens.

The half mirror reflects part of this light, and the reflected light (LA3) passes through the first lens again and enters the second film. Since this light (LA3) is in the second polarization state, it passes through the second polarization film and enters the user's eye. The second film acts as a rear-surface mirror for light (LA1), and the half mirror acts as a rear-surface mirror for light (LA2); furthermore, these rear-surface mirrors have the function of concave mirrors on the side of the half mirror or on both the side of the half mirror and the second film. Under the influence of this concave mirror function, light (LA3) creates an aerial image (Ip) of the display image (Im) of the image display element (DP). The light then enters the user's eye, projecting the aerial image (Ip).

In general, the refractive power of the entire optical system can be calculated by the following formula.

$$Refractive power of the entire optical system = ( 1 / {H}_{1} ) \times ( {H}_{1} \times {Φ}_{1} + {H}_{2} \times {Φ}_{2} + … + {H}_{n} \times {Φ}_{n} )$$

where,
   Hᵢ: height of the light ray at the i-th lens surface from the incident side of the optical axis parallel light entering the optical system (i is an integer)
   Φᵢ: refractive power of the i-th lens surface
   n: number of the final lens surface of the optical system

When explaining the eyepiece optical system by reverse tracing, which tracks the path of light rays from the eye point side to the image display element side, if light parallel to the optical axis is incident, the height of the light ray generally decreases as the light progresses, becoming approximately zero at the image display element. That is, the closer the lens surface is to the eye point side, the higher the light ray height tends to be, and the greater its contribution to the refractive power of the entire system.

In view of this, the eyepiece optical system of the present invention is configured such that the refractive power necessary for creating a wide-field image is generated by the lens on the eye point side, namely the first lens, and the second and third lenses are configured to have the function of correcting the chromatic aberration generated by the first lens. Furthermore, the refractive power of the first lens is generated by the function of a concave mirror on the back surface of the first lens. Since concave mirrors do not generate chromatic aberration, the chromatic aberration of the first lens is considerably reduced compared to when the same refractive power is generated by a normal lens, facilitating chromatic aberration correction by the second and third lenses.

Additionally, by arranging a surface with the function of a back-surface concave mirror in the first lens, the radius of curvature can be made larger compared to when arranged in other lenses (the second and third lenses), i.e., the curvature can be made smaller. Furthermore, as will be described next, the back-surface concave mirror can generate refractive power with a radius of curvature approximately six times that of a refractive convex surface, as will be described below. Therefore, the lens surface on the image display element side of the first lens can have a reduced sag amount, and the first lens can be made thinner from the center to the periphery.

The first lens has the function of a concave mirror, but this concave mirror is a rear-surface mirror type that acts on light traveling through the lens, and its refractive power can be calculated as

2×N1/(radius of curvature of the lens surface)
where,
   N1: refractive index of the first lens for light with a wavelength of 525 nm.

The refractive power of a normal lens surface, that is, a refractive lens surface, is

(refractive index of the material forming the lens−1)/(radius of curvature of the lens surface).

The refractive power of a concave mirror is

(2×refractive index of the material forming the lens)/(radius of curvature of the lens surface).

Therefore, assuming both have the same refractive power and refractive index, and assuming a refractive index of 1.5, when comparing the radius of curvature,

(radius of curvature of the concave mirror)/(radius of curvature of a normal lens)=(2×1.5)/(1.5−1)=6.

Therefore, the present invention can make the radius of curvature very large by using a back-surface concave mirror to achieve the necessary refractive power, compared to using a refractive lens surface of a normal lens. This allows the thickness of the first lens to be reduced. Specifically, as will be described later, the center thickness can be made 10 mm or less.

Here, like in the eyepiece optical system of the present invention, a so-called pancake optical system that creates an image using the function of a concave mirror of an optical element placed between a first film that changes the polarization state of light traveling from the image display element side to the eye point side to a first polarization state, and a second film that reflects light in the first polarization state traveling from the image display element side to the eye point side and changes it to a second polarization state, and transmits light in the second polarization state traveling from the image display element side to the eye point side, creating a one-and-a-half round trip optical path, has retardation (RT: phase difference) in the optical element sandwiched between the first and second films, so if the first polarization state of light traveling from the first film to the second film is disturbed, stray light that is not reflected by the second film but transmitted is generated, causing flare and ghosting in the aerial image. Therefore, the so-called pancake optical system needs to minimize the retardation of the optical element sandwiched between the first and second films.

In the present invention, the optical element sandwiched between the first and second films is limited to the first lens. Therefore, the optical element causing retardation (RT) that leads to stray light is limited to the first lens.

As described above, in the eyepiece optical system of the present invention, a one-and-a-half round trip optical path with a concave mirror in the optical path is created by the action of the first film, the second film, and the half mirror. Here, if retardation (RT) occurs in the light (LA1) passing through the first lens and entering the second film due to the element sandwiched between the first and second films, the first polarization state is disturbed, and part of the light (LA1) is not reflected by the second film but transmitted, generating stray light that superimposes flare and ghosting on the aerial image (Ip). Note that the stronger the retardation, the stronger the stray light. Retardation is caused by the birefringence of the material constituting the lens, and it increases the longer the optical path through the lens. Note that the allowable retardation is approximately 10 nm, as will be described later.

In the present invention, the optical element creating the retardation (RT) is limited to the first lens. Moreover, the radius of curvature of the lens surface on the image display element side of the first lens is large, as described above. Therefore, the first lens can be made thin throughout from the center to the periphery. As a result, the optical path length of light (LA1) passing through the first lens and entering the second film is short, and the retardation (RT) is small.

Therefore, in the present invention, even if a material with relatively large birefringence is used for the first lens, flare and ghosting can be suppressed. Note that since the second and third lenses are positioned on the image display element side of the first film, the retardation generated by these lenses does not create stray light. Therefore, materials with large birefringence can be used for these lenses. That is, any of the first to third lenses can use plastic, which has larger birefringence compared to glass. Plastic can be manufactured more cheaply and is lighter than glass for aspherical lenses.

Thus,

$$0.8 \times P 0 < ( 2 \times N 1 / L 1 e ) + ( 2 \times N 1 / L 1 r ) < 1.2 \times P 0 \qquad ( 1 )$$

When applied to the optical formula, 2×N1/L1e indicates the refractive power due to the rear-surface mirror function of the lens surface on the eye point side of the first lens, and 2×N1/L1r indicates the refractive power due to the rear-surface mirror function of the lens surface on the display side of the first lens.

Therefore, as described above, in the eyepiece optical system of the present invention, the refractive power P0 necessary for creating a wide-field image is generated by the first lens. The refractive power of the first lens is generated by the function of a concave mirror possessed by either or both of the lens surfaces on the eye point side and the image display element side of the first lens, as indicated by conditional expression (1).

Since concave mirrors do not have chromatic aberration, the chromatic aberration generated by the first lens is much smaller compared to a general lens with the same refractive power. This chromatic aberration mainly occurs when light passes through the lens surface on the image display element side of the first lens, due to the bending action of the convex lens. Therefore, the chromatic aberration generated by the first lens has the same orientation as the chromatic aberration generated by a normal convex lens surface, which is referred to as positive chromatic aberration.

In the eyepiece optical system of the present invention, the lens surface on the eye point side of the third lens is convex, and like with the chromatic aberration generated by the lens surface on the image display element side of the first lens, positive chromatic aberration is generated. However, the lens surface on the image display element side of the second lens is concave, generating negative chromatic aberration that cancels out the positive chromatic aberration, and as shown in conditional expression (2), the second lens is made of a material with a smaller Abbe number compared to the third lens, resulting in a large amount of negative chromatic aberration that cancels out the chromatic aberration generated by the lens surface on the image display element side of the first lens and the lens surface on the eye point side of the third lens. This allows the eyepiece optical system of the present invention to reduce chromatic aberration to a level that is not problematic in practice, as will be described later.

As described above, the chromatic aberration of the first lens is much smaller compared to a general lens with the same refractive power, so the curvature of the lens surface on the image display element side of the second lens and the lens surface on the eye point side of the third lens, which correct the chromatic aberration, does not need to be strong; as will be described later, they can be designed to a size that does not disrupt aberrations other than chromatic aberration.

Furthermore, it is desirable for the present invention that the lens surface on the image display element side of the second lens and the lens surface on the eye point side of the third lens satisfy the following conditional expression (3) across the entire aperture of each lens surface.

$$DD < OL / 10 \qquad ( 3 )$$

where,
   DD: maximum value of the interval measured in the optical axis direction between the lens surface on the image display element side of the second lens and the lens surface on the eye point side of the third lens (unit: mm)
   OL: aperture diameter of the lens surface on the image display element side of the second lens (unit: mm)

Note that the aperture of the lens surface means the region through which light rays that create the image can pass.

Additionally, in the present invention, the lens surface on the image display element side of the second lens and the lens surface on the eye point side of the third lens may be bonded together.

(Operation and Effects). Light rays passing through the lens surface on the image display element side of the second lens maintain their height and enter the lens surface on the eye point side of the third lens, but conditional expression (3) constrains the lens surface on the image display element side of the second lens and the lens surface on the eye point side of the third lens to similar shapes. Therefore, the bending angle of the light rays when passing through the lens surface on the eye point side of the second lens is opposite in sign and approximately the same in magnitude as the bending angle of the light rays when passing through the lens surface on the eye point side of the third lens.

That is, the lens surface on the eye point side of the third lens has the function of canceling the bending of light rays at the lens surface on the image display element side of the second lens. Therefore, as described above, the lens surface on the image display element side of the second lens and the lens surface on the eye point side of the third lens have the function of correcting the chromatic aberration of the first lens, but their effect on other aspects is minimized. Therefore, the lens surface on the image display element side of the second lens and the lens surface on the eye point side of the third lens can have optimal curvature and aspherical shape for correcting chromatic aberration. Note that, as will be described later, the region exceeding 80% of the aperture of each lens surface (the lens surface on the image display element side of the second lens or the lens surface on the eye point side of the third lens) is the region through which light rays creating the vicinity of the image edge pass. In particular, in a wide-field eyepiece optical system, the vicinity of the image edge is less frequently directed by the user's line of sight, so chromatic aberration is not a significant issue. On the other hand, the first lens, which generates refractive power through the function of a concave mirror, has overall fewer aberrations compared to a normal refractive lens with the same refractive power, but off-axis aberrations such as coma, astigmatism, and field curvature increase near the image edge. Therefore, in the region exceeding 80% of the aperture of the lens surface on the image display element side of the second lens and the lens surface on the eye point side of the third lens, it is not necessary to satisfy conditional expression (3), and it is preferable to use the aspherical function of these lens surfaces to correct the aforementioned off-axis aberrations. Here, the region exceeding 80% of the aperture refers to the region other than where a light beam with a diameter of 80% of the effective light beam diameter passes through the lens surface on the image display element side of the second lens and the lens surface on the eye point side of the third lens.

Furthermore, it is desirable for the present invention to satisfy the following conditional expressions (4) and (5).

$$\vert SAG 1 ( h 1 ) \vert < 0.05 \times h 1 \qquad ( 4 )$$

$$\vert SAG 2 ( h 2 ) \vert < 0.05 \times h 2 \qquad ( 5 )$$

where,
   SAG1(h1): sag amount at the position of height h1 (unit: mm) within the aperture diameter from the optical axis of the lens surface on the eye point side of the first lens (unit: mm)
   SAG2(h2): sag amount at the position of height h2 (unit: mm) within the aperture diameter from the optical axis of the lens surface on the eye point side of the second lens (unit: mm)
Note that the sag amount is the coordinate in the optical axis direction of the lens surface, with the reference being the position where the lens surface and the optical axis intersect.

(Operation and Effects). It is preferable for the first film and the second film, which are polarization control films, to be laminated on a plane. When a polarization control film is laminated on a curved surface, tension is applied to the film, causing distortion in the polarization control characteristics, and the film is more likely to peel off under high temperature and high humidity conditions. However, if the eyepiece optical system of the present invention satisfies the above conditional expressions (4) and (5), when the first film and the second film are laminated on the lens surface on the eye point side of the second lens and the lens surface on the eye point side of the first lens, respectively, each film changes shape to conform to the respective lens surface with an expansion rate of about 0.7% or less. At this expansion rate, the impact on the polarization characteristics of the first film and the second film is minimal, and the risk of increased peeling is also minimal.

Note that a linear polarizer is often used as the film constituting the polarization control film, but linear polarizers are weak to heat. The image display element emits heat. In the eyepiece optical system of the present invention, the second and third lenses are located between the first film and the image display element, and their thermal insulation function protects the first film from heat, preventing thermal degradation of the first film.

Furthermore, in the present invention, the lens surface on the image display element side of the second lens, in the region up to 80% of the aperture, has a curvature at the periphery that increases in the direction where the concave becomes stronger (negative direction) compared to the center curvature of the lens surface, and the lens surface on the eye point side of the third lens, in the region up to 80% of the aperture, has a curvature at the periphery that increases in the direction where the convex becomes stronger (positive direction) compared to the center curvature of the lens surface. The lens surface on the image display element side of the second lens and the lens surface on the eye point side of the third lens have the function of correcting the chromatic aberration generated by the first lens. One of the chromatic aberrations generated by the first lens is the chromatic aberration of magnification, which becomes larger as the image height increases and needs to be corrected, although the need for correction is lower in the central part of the image. Light rays creating images with high image height pass through parts of the lens surface on the image display element side of the second lens and the lens surface on the eye point side of the third lens that are distant from the optical axis.

Therefore, by having the curvature of the lens surface on the image display element side of the second lens and the lens surface on the eye point side of the third lens, in the region up to 80% of the aperture, be large in the negative direction for the lens surface on the image display element side of the second lens and large in the positive direction for the lens surface on the eye point side of the third lens relative to their center curvature, the chromatic aberration of magnification generated at high image heights of the first lens can be sufficiently corrected. Compared to constructing the lens surface on the image display element side of the second lens and the lens surface on the eye point side of the third lens as spherical surfaces to correct equivalent chromatic aberration, the sag amount at the edge of the lens surface on the image display element side of the second lens and the lens surface on the eye point side of the third lens can be reduced. Therefore, the thickness of the second lens including the edge and the thickness of the third lens can each be reduced, and the distance between the first lens and the third lens can be shortened. This has the effect of moving the rear focal position in reverse tracing of the eyepiece optical system further towards the image display element side.

As the refractive power P0 of the eyepiece optical system of the present invention is increased, the rear focal position in reverse tracing of the eyepiece optical system moves towards the eye point side and eventually sinks into the third lens. Since the display surface of the image display element needs to be positioned at or near this rear focal position, mechanical interference between the third lens and the image display element occurs. By having the curvature of the lens surface on the image display element side of the second lens and the lens surface on the eye point side of the third lens, in the region up to 80% of the aperture, be large in the negative direction for the lens surface on the image display element side of the second lens and large in the positive direction for the lens surface on the eye point side of the third lens relative to their center curvature, the aforementioned interference can be prevented, and the refractive power P0 of the eyepiece optical system can be increased. If the refractive power P0 of the eyepiece optical system can be increased, the field of view angle FOV of the image display of the eyepiece optical system can be increased.

Note that the region exceeding 80% of the aperture of each lens surface is the region through which light rays creating the vicinity of the image edge pass. In particular, in a wide-field eyepiece optical system, the vicinity of the image edge is less frequently directed by the user's line of sight, so chromatic aberration is not a significant issue. Therefore, the need for correcting chromatic aberration generated in light rays passing through the region exceeding 80% of the aperture of each lens surface is minimal. Accordingly, the curvature of the lens surface on the image display element side of the second lens and the lens surface on the eye point side of the third lens, in the region exceeding 80% of the aperture, may be increased in the positive direction for the lens surface on the image display element side of the second lens and in the negative direction for the lens surface on the eye point side of the third lens, reducing the sag amount of each surface.

Note that in the eyepiece optical system of the present invention, the lens surface on the image display element side of the second lens is concave, and the lens surface on the eye point side of the third lens is convex. However, if ν2>ν3 instead of ν2<ν3, and the convex and concave configurations are reversed, that is, if the lens surface on the image display element side of the second lens is convex and the lens surface on the eye point side of the third lens is concave, when correcting chromatic aberration, as will be described later, it is preferable for the lens surface on the image display element side of the third lens to be convex, resulting in the third lens becoming a meniscus lens. This makes it difficult to sufficiently impart negative refractive power to the third lens, and chromatic aberration cannot be sufficiently corrected. Therefore, it is preferable for the eyepiece optical system of the present invention to have the lens surface on the image display element side of the second lens be concave and the lens surface on the eye point side of the third lens be convex, as described above.

Furthermore, in the present invention, it is desirable for the rear focal position of the first lens, that is, the front focal position in reverse tracing, to be on the eye point side of the second film and satisfy the following conditional expression (6).

$$9 < F F < 15 \qquad ( 6 )$$

where,
   FF: distance from the second film to the rear focal position of the first lens (unit: mm)

(Operation and Effects). In general, glasses are sold with the distance from the glasses lens to the user's eye adjusted to around 12 mm when worn. If this distance is shorter than 12 mm, eyelashes may touch the lens, making it prone to getting dirty, or tear droplets may adhere to the lens, making it prone to getting dirty. For similar reasons, the distance between the user's eye and the lens of an HMD (eye relief) is likely to be used around 12 mm.

On the other hand, the necessary aperture diameter (DF) of the lens surface on the eye point side of the second film, which is the most eye point side lens surface in the HMD in the present invention, can be calculated by the following formula. That is, it increases approximately in proportion to the eye relief (ER).

$$DF = 2 \times E R \times tan ( FOV / 2 ) + α ( mm )$$

where,
   FOV: field of view angle of the image display of the eyepiece optical system (unit: degrees)
   α: margin for the aperture diameter (unit: mm, 0 to 5 mm in the present invention) DF: aperture diameter of the lens surface on the eye point side including the margin (unit: mm, aperture diameter on the eye point side of the second film in the present invention)
   ER: distance between the eye point and the most eye point side lens surface of the HMD (unit: mm)

Here, if the diameter of the lenses constituting the eyepiece optical system increases, the overall weight of the HMD increases, making the HMD less user-friendly. Particularly when the FOV exceeds 90 degrees, the overall weight of the HMD increases significantly with the increase in the distance ER between the eye and the HMD lens. Therefore, it is not preferable to design with an unnecessarily large value for the distance ER between the eye and the HMD lens. Therefore, when designing an HMD for use without glasses, the preferred assumed value for the distance ER between the eye and the HMD lens is 10 mm or more and 14 mm or less.

On the other hand, there are cases where an HMD is designed to be used while the user is wearing glasses. In this case, it is advisable to design the distance ER between the eye and the HMD lens to be around 20 mm. However, in this case, it is preferable to keep the FOV at 100 degrees or less to prevent the lens aperture from becoming too large and the HMD from becoming too heavy.

The eyepiece optical system of the present invention, according to conditional expression (6), has the rear focal position of the first lens, that is, the front focal position in reverse tracing, at 9 to 15 mm. Therefore, when an HMD equipped with the eyepiece optical system of the present invention is used with the distance ER between the eye and the HMD lens being 10 to 14 mm, the light ray (principal ray) passing through the center of the user's pupil becomes approximately parallel to the optical axis between the first lens and the second lens. Additionally, when the distance ER between the eye and the HMD lens is 20 mm, the principal ray inclines such that the ray height decreases towards the image display element side between the first lens and the second lens.

Hereinafter, the light ray (principal ray) passing through the center of the user's pupil will be described by tracing (reverse tracing) from the eye point side towards the image display element side. As described above, since the first lens is thin and the lens surface on the image display element side of the first lens is convex, the thickness at the edge of the first lens is even thinner. That is, the lens surface on the eye point side of the first lens and the lens surface on the image display element side are in close proximity in the optical axis direction near the edge. Therefore, the principal ray at the field edge makes one and a half round trips between the lens surface on the eye point side of the first lens and the lens surface on the image display element side, maintaining approximately the same height (ray height) as it proceeds towards the second lens. As described above, the principal ray proceeds approximately parallel to the optical axis or with a decreasing ray height from the first lens towards the second lens.

The lens surface on the eye point side of the second lens preferably has a sag amount of |SAG2(h2)|<0.05×h2, as described above, and is flat or approximately flat. Therefore, the principal ray continues to proceed approximately parallel to the optical axis or with a decreasing ray height towards the lens surface on the image display element side of the second lens after passing through the lens surface on the eye point side of the second lens. Furthermore, since the edge thickness of the third lens is small and, as described above, the lens surface on the eye point side of the third lens cancels the bending of light rays at the lens surface on the image display element side of the second lens, the principal ray exiting the lens surface on the eye point side of the second lens reaches the lens surface on the image display element side of the third lens without significantly changing its inclination relative to the optical axis. In this way, the principal ray at the field edge passes through each lens surface with a ray height approximately the same as or lower than the ray height at the lens surface on the eye point side of the first lens.

Each lens surface's aperture only needs to be large enough for the principal ray at the field edge to pass through. By satisfying the above conditional expression (6) “9<FF<15,” the eyepiece optical system of the present invention can make the aperture diameter of each lens surface in the entire optical system equal to or smaller than the aperture diameter on the eye point side of the second film. Note that the aperture diameter DF of the lens surface on the eye point side of the first lens is a value determined by the lens specifications, as is clear from the above “DF=2×ER×tan(FOV/2)+α (mm),” and cannot be reduced by design ingenuity. Therefore, conditional expression (6) can be said to be a condition for making the thickness of the lens in the eyepiece optical system as thin as the limits determined by the specifications.

To ensure the effect of the present invention, it is preferable to set the lower limit of conditional expression (6) to 10. Additionally, to ensure the effect of the present invention, it is preferable to set the upper limit of conditional expression (6) to 14.

Furthermore, it is desirable for the present invention to satisfy the following conditional expression (7).

$$DN < 1.2 \times D F \qquad ( 7 )$$

where,
   DF: aperture diameter on the eye point side of the second film (unit: mm)
   DN: aperture diameter of the lens surface with the largest aperture diameter among the lens surfaces other than the lens surface on the eye point side of the first lens (unit: mm)

(Operation and Effects). Each lens surface's aperture diameter only needs to be large enough for the principal ray at the field edge to pass through, but it is preferable to have some margin in the aperture diameter. By having a margin in the aperture diameter, for example, vignetting that occurs when the user's pupil is displaced from the optical axis of the optical system can be prevented or reduced. However, if the margin of the aperture diameter of the lens surface on the eye point side of the first lens is larger than the margin of the aperture diameter of other lens surfaces, when the user looks into the HMD, the edge of the aperture of the lens surface on the eye point side of the first lens naturally enters the field of view, but the edge of the aperture of lens surfaces other than the lens surface on the eye point side of the first lens also becomes more visible. Since light is easily scattered at the edge of the aperture, becoming stray light, this state is not preferable. Therefore, by making the margin of the aperture diameter of lens surfaces other than the lens surface on the eye point side of the first lens larger than the margin of the aperture diameter of the lens surface on the eye point side of the first lens, the edge of the aperture of lens surfaces other than the lens surface on the eye point side of the first lens is shielded by the aperture of the lens surface on the eye point side of the first lens, preventing stray light.

This method of providing a margin in the aperture diameter results in making the aperture diameter DN of the lens surface with the largest aperture diameter among the lens surfaces other than the lens surface on the eye point side of the first lens larger than the aperture diameter DF on the eye point side of the second film, resulting in increasing the outer diameter of the second lens or the third lens. However, when providing a margin in the aperture diameter, it is preferable to keep it within a range where sufficient effect is obtained. Specifically, even if a margin is given to the aperture diameter DN, if it is kept within a range not exceeding 1.2×DF, stray light can be prevented, and the increase in the outer diameter of the lens can be kept minimal.

As described above, the aperture diameter DF can be calculated by the following formula.

$$( DF = 2 \times E R \times tan ( FOV / 2 ) + α ( unit : mm )$$

Here, α is assumed to be from 0 mm to the average diameter of the pupil, 4 mm, and ER is assumed to be 10 to 14 mm when not using glasses at FOV 90 degrees or more, and 20 mm when using glasses at FOV 100 degrees or less; calculating DF with these five combinations results in the following.

FOV (degrees) ER (mm) α(mm) DF (mm)

$$110 \; 12 \; 0 - 4 \; 34 - 38$$

$$1 \; 05 \; 12 \; 0 - 4 \; 31 - 35$$

$$90 - 12 \; 0 - 4 \; 24 - 28$$

$$90 \; 20 \; 0 - 4 \; 41 - 44$$

$$80 \; 20 \; 0 - 4 \; 34 - 38$$

From these results, it can be said that the optimal value for DF in implementing the present invention is 24 mm to 38 mm.

Furthermore, it is desirable for the present invention that the lens surface on the eye point side of the first lens is flat or approximately flat and satisfies the following conditional expressions (8) to (10). These conditional expressions (8) to (10) do not contradict the above conditional expression (6) “9<FF<15.”

$$44 < L 1 r < 65 \qquad ( 8 )$$

$$0 < L 1 d < 5 \qquad ( 9 )$$

$$1.45 < N 1 < 1.55 \qquad ( 10 )$$

where,
   L1r: radius of curvature of the lens surface on the image display element side of the first lens (unit: mm)
   L1d: thickness in the optical axis direction of the edge portion of the first lens (unit: mm)
   N1: refractive index of the first lens for light with a wavelength of 525 nm

In the present invention, to suppress the retardation (RT) of the first lens, it is preferable for the first lens to be thin, and it is not preferable to unnecessarily increase the thickness of the edge of the first lens. Therefore, it is preferable for the thickness of the edge of the first lens to satisfy the above conditional expression (9).

Furthermore, if the first lens satisfies the above conditional expression (8), as shown by the following formula for sag, the sag at the edge of the lens surface on the image display element side of the first lens is less than 5 mm, and if the center thickness is made thicker than 5 mm, it can be made 0<L1d. That is, the center thickness of the first lens can be made 10 mm or less.

$$Sag = \vert L 1 r \vert - {\{ {( L 1 r )}^{2} - {( DF / 2 )}^{2} \}}^{1 / 2} < 5 mm$$

Note that for simplicity in the calculation, the lens surface on the image display element side of the first lens is considered spherical. Also, based on the above calculation example and conditional expression (8), respectively, DF and L1r are assumed to be as follows.

$$DF < 40 mm$$

$$44 < L 1 r$$

If the center thickness of the first lens is 10 mm or less, the first lens can be manufactured using a material with birefringence of about 1×10⁻⁶. In addition, there are several types of plastic materials that satisfy the above conditional expression (10), which can be used to manufacture the first lens, making it preferable. Note that, as will be described below, the above conditional expressions (8) to (10) do not contradict the above conditional expression (6) “9<FF<15.”

The refractive power when the lens surface on the image display element side of the first lens acts as a concave mirror is 2×N1/L1r, and the focal length is the reciprocal of this. Substituting the above conditional expression (8) into this reciprocal formula, the focal length (RF) of the lens surface on the image display element side of the first lens is

14 mm<RF<21 mm.

If the center thickness of the first lens is set to 5 to 10 mm based on the above content, the optical path length of the center thickness of the first lens is less than (5-10 mm)/(1.45-1.55)≈3.2-6.9 mm.
The front focal position (FF) of the first lens can be roughly estimated by subtracting this optical path length from the focal length RF.

$$FF \approx ( 14 - 21 mm ) - 3.2 - 6.9 mm ) = 7.1 - 17.8 mm$$

which does not contradict the above conditional expression (6).

To ensure the effect of the present invention, it is preferable to set the upper limit of conditional expression (8) to 60. To ensure the effect of the present invention, it is preferable to set the upper limit of conditional expression (9) to 3.5. Additionally, to further ensure the effect of the present invention, it is preferable to set the upper limit of conditional expression (9) to 2.

Furthermore, it is desirable for the present invention to satisfy the following conditional expression (11).

$$ID < 0.9 \times D F \qquad ( 11 )$$

where,
   ID: the dimension of the image displayed on the image display surface of the image display element, projected by the eyepiece optical system when the eyepiece optical system enlarges and projects the image (in whole or in part) displayed on the image display surface of the image display element into the air (unit: mm)
   DF: aperture diameter on the eye point side of the second film (unit: mm)

(Operation and Effects). To realize a slim, i.e., small-diameter, eyepiece optical system, it is necessary to reduce the diameter of the lenses constituting the eyepiece optical system and further reduce the mechanical outer dimensions of the image display element. The mechanical outer dimensions of the image display element are larger than the dimensions of the image display surface. Considering this, it is preferable for the dimensions of the image display surface of the image display element to be smaller than the aperture diameter DF on the eye point side of the second film, which serves as the reference for the lens aperture diameter. This is indicated by the above conditional expression (11).

Furthermore, it is desirable for the lens surface on the image display element side of the third lens to be an aspherical surface where the center protrudes outward in the optical axis direction more than the edge (the outer peripheral part of the region through which light passes through the lens surface). This allows the present invention to more effectively satisfy the above conditional expression (11).

(Operation and Effects). With this configuration, the lens surface on the image display element side of the third lens in the eyepiece optical system of the present invention will have a convex shape towards the eye point side, at least at the edge. When reverse tracing the principal ray at the field edge passing through the edge, the refractive action of the lens surface on the image display element side of the third lens causes the principal ray to bend in a direction where the ray height decreases towards the image display element after passing through the lens surface on the image display element side. The principal ray height at the field edge on the display surface of the image display element indicates the size of the image that must be displayed on the display surface of the image display element. By making the lens surface on the image display element side of the third lens convex, the effect of reducing the size of the image by the image display element is achieved. This allows the dimensions of the image display surface of the image display element to be smaller than the aperture diameter DF on the eye point side of the second film, which serves as the reference for the lens aperture diameter.

Furthermore, to reduce the principal ray height at the field edge by a predetermined amount, if the lens surface on the image display element side of the third lens is made as an aspherical surface with a larger curvature than the center curvature in the direction of forming a convex surface from the center towards the outer periphery, the sag amount at the edge can be reduced compared to making the lens surface spherical. If this sag amount is large, the center thickness of the third lens becomes thicker to secure the manufacturable edge thickness of the third lens, and the rear focal position of the entire eyepiece optical system in reverse tracing sinks into the third lens. In this case, since the image display surface of the image display element needs to be placed near the rear focal position, the image display element cannot be positioned. To avoid this, it is preferable for the lens surface on the image display element side of the third lens to be an aspherical surface with increasing curvature in the direction of forming a convex surface towards the outer periphery.

Note that the refractive power (P3R) of the lens surface on the image display element side of the third lens has little effect on the refractive power P0 of the eyepiece optical system. This is because, in the previously mentioned<overall focal length calculation formula>, the height (Hᵢ) of the light ray on the lens surface on the image display element side of the third lens is extremely low compared to the height of the light rays on other lens surfaces. The fact that the refractive power P0 of the eyepiece optical system hardly changes due to the action of the lens surface on the image display element side of the third lens, and the principal ray height on the image display surface of the image display element decreases, indicates that the lens surface on the image display element side of the third lens is acting to create negative distortion.

Furthermore, it is desirable for the present invention to satisfy the following conditional expressions (12) to (14).

$$80 < FOV \qquad ( 12 )$$

$$0.04 5 < ( 2 \times N 1 / L 1 e ) + ( 2 \times N 1 / L 1 r ) < 0.0 \; 65 \qquad ( 13 )$$

$$DIS < - 20 \qquad ( 14 )$$

where,
   FOV: field of view angle of the image display of the eyepiece optical system (unit: degrees)
   N1: refractive index of the first lens for light with a wavelength of 525 nm
   L1e: radius of curvature of the lens surface on the eye point side of the first lens (unit: mm)
   L1r: radius of curvature of the lens surface on the image display element side of the first lens (unit: mm)
   DIS: distortion in reverse tracing (unit: %)
Note that the radii of curvature L1e and L1r are positive for convex surfaces.

The definition of distortion in reverse tracing is as follows.

$$II = ( 1 / P 0 ) \times tan β$$

$$DIS ( \% ) = \{ ( RI - II ) / II \} \times 100 \%$$

where,
   II: height of the principal ray on the display surface in the absence of distortion (unit: mm)
   P0: refractive power of the eyepiece optical system (unit: mm⁻¹)
   β: angle of the principal ray incident on the first lens (unit: degrees)
   RI: height of the principal ray on the image display surface of the image display element (distance from the optical axis) (unit: mm)

Also, it is assumed that the image display position is sufficiently far from the eyepiece optical system.

(Operation and Effects). Conditional expression (12) is the FOV realized by the present invention, and conditional expressions (13) and (14) indicate preferable conditions that satisfy conditional expression (11) “ID<0.9×DF” while satisfying conditional expression (12). This is confirmed for the following two cases.
However, to simplify the calculation, the inequality in conditional expression (13) uses the median value,

$$( 2 \times N 1 / L 1 e ) + ( 2 \times N 1 / L 1 r ) = ( 0.045 + 0.0 \; 65 ) / 2 = 0.055 .$$

Therefore, calculating P0 from conditional expression (1) “0.8×P0< (2×N1/L1e)+ (2×N1/L1r)<1.2×P0”
results in

$$0.0 \; 55 / 1.2 < P 0 < 0.0 \; 55 / 0.8 ( {mm}^{- 1} )$$

$$0.046 < P 0 < 0.0 \; 69 ( {mm}^{- 1} ) .$$

### [Setting Conditions for the First Case]

FOV=100 degrees (i.e., the inclination angle of the principal ray incident on the first lens is 50 degrees)
ER=12 mm
Distortion=−35%
P0=0.065 mm⁻¹: a value close to the upper limit of the above P0 calculation

### [Setting Conditions for the Second Case]

FOV=80 degrees (i.e., the inclination angle of the principal ray incident on the first lens is 40 degrees)
ER=20 mm
Distortion=−20%
P0=0.045 mm⁻¹: a value close to the lower limit of the above P0 calculation

### [Calculating the First Case].

$$DF = 2 \times E R \times tan ( FOV / 2 ) + α$$

$$and assuming α = 0 ,$$

$$DF = 28.6 mm .$$

According to conditional expression (11) “ID<0.9×DF,”
ID must be less than 25.7 mm.
On the other hand,

$$II = ( 1 / P 0 ) \times tan β$$

$$so$$

$$II = 18.3 mm .$$

Therefore,
when distortion is 0%, RI=18.3 mm
when distortion is −35%, RI=(1−0.35)×II=11.9 mm
Since ID is twice RI, when distortion is 0%, ID=36.6 mm, which does not satisfy the calculated ID<25.7 mm from conditional expression (11). However, when distortion is −35%, ID=23.8 mm, which satisfies the calculated ID<25.7 mm from conditional expression (11).

### [Calculating the Second Case]

$$DF = 2 \times ER \times tan ( FOV / 2 ) + α$$

$$and assuming , α = 0 ,$$

$$DF = 33.6 mm .$$

Therefore, from conditional expression (12) “ID<0.9×DF,”
ID must be less than 30.2 mm.

On the other hand,

$$II = ( 1 / P 0 ) \times tan β$$

$$so$$

$$II = 18.6 mm .$$

Therefore,
when distortion is 0%, RI=18.6 mm
when distortion is −20%, RI=(1−0.2)×II=14.8 mm
Since ID is twice RI, when distortion is 0%, ID=36.2 mm, which does not satisfy the calculated ID<30.2 mm from conditional expression (11). However, when distortion is −20%, ID=29.6 mm, which satisfies the calculated ID<30.2 mm from conditional expression (11). To ensure the effect of the present invention, it is preferable to set the lower limit of conditional expression (12) to 82 and the upper limit of conditional expression (14) to −22.

Furthermore, it is desirable for the present invention to perform diopter adjustment by varying the air gap between the first lens and the second lens.

(Operation and Effects). The present invention allows for diopter adjustment with minimal changes in FOV and aberration. Since the refractive power of the first lens is large, the amount of adjustment needed for the gap is small.
The adjustment amount per diopter is 1/(1000×P0²) mm.
The refractive power of the first lens≈(2×N1/L1e)+ (2×N1/L1r)

$$0.045 < ( 2 \times N 1 / L 1 e ) + ( 2 \times N 1 / L 1 r ) < 0.065$$

Even when P0=0.05, the adjustment amount per diopter is
1/(1000×0.05²)=0.4 mm, which is small.

Furthermore, when assuming the user does not wear glasses, the eye relief ER is 10-14 mm, and the principal ray between the first lens and the second lens is approximately parallel to the optical axis. Therefore, even if the gap in this area is changed for diopter adjustment, the height of the principal ray does not change significantly, resulting in minimal changes in FOV and aberration. If an eyepiece optical system with significant FOV changes due to diopter adjustment is used by a user with different prescriptions for each eye, the size of the images seen by each eye would differ, causing discomfort, but this is not the case here.

Furthermore, it is desirable for the present invention to further include a fourth lens for diopter correction on the eye point side of the first lens. The fourth lens for diopter correction has positive or negative refractive power and functions as a spectacle lens.

(Operation and Effects). The present invention allows for the development of products with different diopters. The basic lens configuration is common, making it easy to design and manufacture products with different diopters.

Furthermore, it is desirable for the fourth lens to be insertable and removable between the eye point and the first lens.

(Operation and Effects). The present invention allows the user to change the diopter. The user can adjust the eyepiece optical system of the present invention to a diopter that suits their eyes. When performing diopter adjustment by varying the air gap between the first lens and the second lens, the adjustment range is limited. Even users with diopters beyond this adjustment range can use the eyepiece optical system of the present invention.

Furthermore, it is desirable for the first lens to be made of plastic and for the lens surface on the image display element side of the first lens to be aspherical.

(Operation and Effects). Experiments have shown that retardation, which causes flare and ghosting, can be tolerated up to 10 nm. According to the present invention, the retardation causing flare and ghosting is only the retardation generated by the first lens in the light (LA1) passing through the first lens and entering the second film. Furthermore, since the first lens can be made thin according to the present invention, the material of the first lens may have relatively large birefringence. Focusing on this, the present invention manufactures the first lens from plastic. Plastic is lighter than glass. Additionally, plastic can be used to inexpensively manufacture aspherical lenses, which have higher aberration correction capabilities than spherical lenses. Although it is preferable for the lens surface on the eye point side of the first lens to be flat or approximately flat, even in such cases, making the lens surface on the image display element side of the first lens aspherical can sufficiently reduce aberrations.

According to the present invention, the thickness of the first lens can be reduced to 10 mm or less, and the retardation is 10 nm. Therefore, the birefringence of the material used for the first lens can satisfy the following condition.

$$Δ n < 1 \times 1 {0}^{- 6}$$

where,
   Δn: the difference between the maximum and minimum refractive indices for linearly polarized light in any orientation. There are several plastics that satisfy this condition and can be used for manufacturing the first lens. For example, AZP (registered trademark) by Asahi Kasei Corporation, Optimas (registered trademark) by Mitsubishi Gas Chemical Company, Inc., and APEL (registered trademark) by Mitsui Chemicals, Inc. can be used for manufacturing the first lens.

Furthermore, it is desirable for the second lens and the third lens to be made of plastic, and for the lens surface on the image display element side of the second lens, the lens surface on the eye point side of the third lens, and the lens surface on the image display element side of the third lens to be aspherical.

(Operation and Effects). Wide-field eyepiece optical systems generally have difficulty in aberration correction and require many lenses when constructed with spherical lenses. However, according to the present invention, chromatic aberration can be corrected with only the two lenses, the second lens and the third lens. By making each lens surface of the second lens and the third lens aspherical, aberrations other than chromatic aberration can also be corrected. Therefore, the eyepiece optical system can be composed of a total of three lenses. Note that the retardation generated by the second lens and the third lens does not cause flare or ghosting, so there are many options for plastic materials.

Furthermore, it is desirable for the first polarization state to be circular polarization and for the second polarization state to be circular polarization with a rotation direction opposite to that of the first polarization state.

(Operation and Effects). These polarization states can be easily created with existing polarization control films. Furthermore, unlike linear or elliptical polarization, circular polarization does not have a specific orientation axis. Therefore, the first film can have any azimuth angle relative to the optical axis, allowing for a relaxed tolerance of the azimuth angle when laminated on the lens surface on the eye point side of the second lens. Similarly, the second film can have any azimuth angle relative to the optical axis, allowing for a relaxed tolerance of the azimuth angle when laminated on the lens surface on the eye point side of the first lens.

Furthermore, it is desirable for the second film to be a laminated film having a reflective polarizer and a quarter-wave plate in order from the eye point side, with the slow axis of the quarter-wave plate inclined at 45 degrees to the transmission axis of the reflective polarizer when viewed from the eye point side, and for the first film to be a laminated film having a quarter-wave plate and a linear polarizer in order from the eye point side, with the slow axis of the quarter-wave plate inclined at 45 degrees to the transmission axis of the linear polarizer when viewed from the eye point side.

(Operation and Effects). According to this configuration, when light emitted from the image display element enters the first film, it becomes linearly polarized by the linear polarizer and then becomes circularly polarized by passing through the quarter-wave plate, which is the first polarization state. Furthermore, when this light enters the second film, it becomes linearly polarized by the quarter-wave plate and heads towards the reflective polarizer. The reflective polarizer has a transmission axis orthogonal to the polarization axis of the incident linearly polarized light and reflects the incident linearly polarized light. This reflected light passes through the quarter-wave plate of the first film again, becoming circularly polarized with a rotation opposite to the first polarization state. This is the second polarization state. Part of the light in this second polarization state is reflected by the half mirror of the first lens while maintaining its polarization state. When this light enters the second film again and passes through the quarter-wave plate, it becomes linearly polarized parallel to the transmission axis of the reflective polarizer and passes through the reflective polarizer towards the eye point side.

Furthermore, it is desirable for the second film to further include a polarizer on the eye point side of the reflective polarizer, having a transmission axis parallel to the transmission axis of the reflective polarizer.

(Operation and Effects). Existing reflective polarizers cannot sufficiently block the polarization of the absorption axis. Therefore, even if the light in the first polarization state entering the second film is ideally converted to linearly polarized light by the quarter-wave plate, part of that light may pass through the reflective polarizer. This light that passes through the reflective polarizer becomes stray light when it reaches the user's eye. However, by providing a polarizer on the eye point side of the reflective polarizer, with a transmission axis parallel to the transmission axis of the reflective polarizer, the light that passes through the reflective polarizer and the polarizer have orthogonal polarization axes. Therefore, the light that passes through the reflective polarizer is absorbed by the polarizer, preventing stray light.

Furthermore, it is desirable for the first film to further include a quarter-wave plate (QWP2s) on the image display element side of the linear polarizer.

(Operation and Effects). When light emitted from the image display element enters the half mirror of the first lens, part of it is transmitted, and the rest is reflected towards the image display element side. This reflected light is relatively strong because it is reflected by the half mirror. Also, when light emitted from the image display element enters the second film, part of it is transmitted, and the rest is reflected towards the image display element side. When this reflected light is reflected by the second lens, the third lens, and the image display element and returns to the eye point side, part of it becomes stray light. The eyepiece optical system of the present invention can block this stray light by providing a quarter-wave plate on the image display element side of the linear polarizer of the first film. Specifically, when light reflected by the half mirror or the second film passes through the first film, it passes through the second layer linear polarizer and the quarter-wave plate on the image display element side, becoming circularly polarized. When the circularly polarized light is reflected again by the lens surface or the image display element and enters the first film, it first passes through the quarter-wave plate, becoming linearly polarized light with a polarization axis orthogonal to the second layer linear polarizer. This light is absorbed by the second layer linear polarizer, preventing stray light.

A quarter-wave plate (QWP2s) with such an effect, provided on the image display element side of the linear polarizer of the first film, is preferably placed near the half mirror, as it can block stray light caused by reflections between the half mirror and the quarter-wave plate. In the present invention, since the quarter-wave plate is placed on the lens surface on the eye point side of the second lens, which is closest to the half mirror coated on the lens surface on the image display element side of the first lens, its effect is significant.

Furthermore, the present invention provides a wide-field image display device characterized by being equipped with the above eyepiece optical system. This allows for the realization of a wide-field image display device that suppresses the occurrence of flare, ghosting, and chromatic aberration.

Furthermore, it is desirable for the third lens to be a plastic lens manufactured by injection molding, provided with a D-cut surface on the outer periphery, and further provided with a gate for injection molding on the D-cut surface, with the third lens being arranged in the barrel so that the D-cut surface faces the user's nose side.

(Operation and Effects). To achieve achromatism with the combination of the second lens and the third lens, the absolute values of the refractive power of the second lens and the third lens need to be large. Therefore, the convex surface on the image display element side of the third lens becomes steep, and the edge thickness becomes small. In such a third lens, it is difficult to sufficiently secure the dimension in the optical axis direction of the gate for injection molding (vertical dimension of the gate). Therefore, by forming a D-cut surface by cutting away part of the outer periphery of the third lens and providing a gate on the D-cut surface, a sufficient vertical dimension of the gate can be secured. The third lens is then arranged in the barrel so that the D-cut surface faces the user's nose side. This way, even if part of the light rays creating the image is vignetted at the D-cut portion of the third lens, and part of the image is missing, the orientation is towards the user's nose side, making it less likely for the user to feel discomfort.

Note that in the eyepiece optical system of the present invention, for chromatic aberration correction, the lens surface on the image display element side of the second lens is concave, and the lens surface on the eye point side of the third lens is convex. If the relationship between ν1 and ν2 is reversed, and the convex and concave configurations are reversed, that is, if the lens surface on the image display element side of the second lens is convex and the lens surface on the eye point side of the third lens is concave for chromatic aberration correction, the lens requiring a D-cut surface as described above becomes the second lens. When incorporating the eyepiece optical system of the present invention into a binocular housing, the left eye side should have the D-cut surface positioned at the lower right, and the right eye side should have the D-cut surface positioned at the lower left, meaning that each D-cut surface should be oriented towards the user's nose side, requiring a change in orientation.

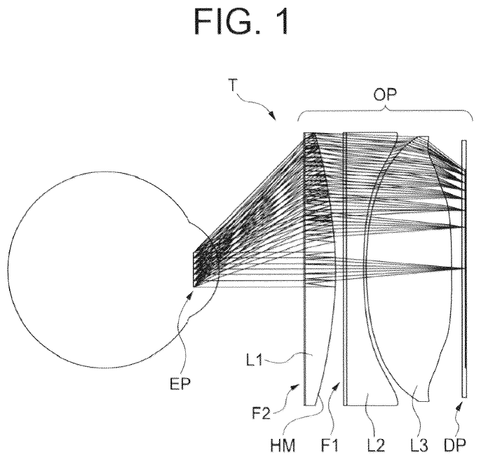

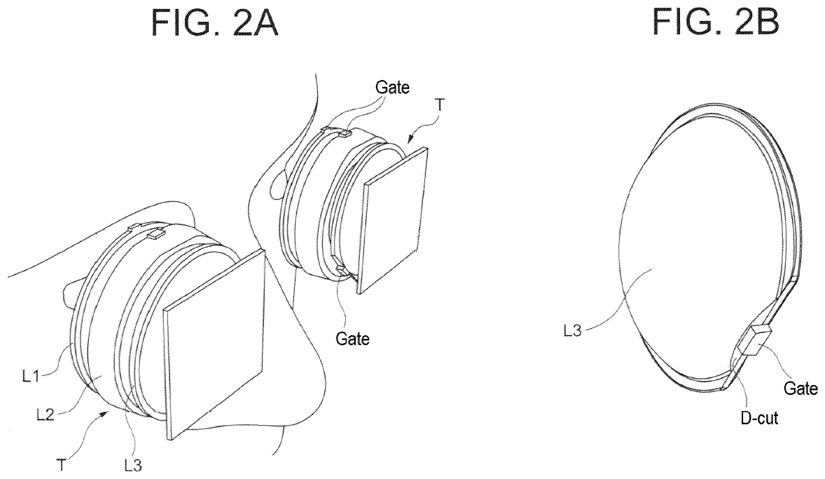

However, the first film is laminated on the lens surface on the eye point side of the second lens. For example, if the first film is a film that creates a circular polarization state, and its characteristics are imperfect, resulting in the first polarization state becoming elliptical polarization, when incorporating the eyepiece optical system of the present invention into a binocular housing and changing the orientation of the second lens for the left and right as described above, flare and ghosting due to elliptical polarization will occur differently in the images seen by the user's left and right eyes. This will cause discomfort when the user views the overlapping images with both eyes. For these reasons, it is preferable for the lens surface on the image display element side of the second lens to be concave and the lens surface on the eye point side of the third lens to be convex.

<Regarding WO 2022/038777>. WO 2022/038777 has large chromatic aberration, resulting in reduced resolution at the periphery of the image. The eye-side surface of the lens on the image display element side is convex, and light passes through it three times. Chromatic aberration occurs each time, but it is not corrected. Therefore, the eyepiece optical system has large chromatic aberration of magnification. Many image display elements used in HMDs have a spectrum of emitted image light with a certain width. Therefore, when using these image display elements, the point image becomes radially blurred towards the periphery of the image due to chromatic aberration of magnification. This results in a decrease in tangential MTF.

<Regarding JP 2022-88582 A>. JP 2022-88582 A has corrected chromatic aberration but is prone to flare and ghosting. The film is laminated on a curved surface, causing the polarization characteristics of the film to deteriorate, making it prone to flare and ghosting. Furthermore, there are two lenses sandwiched between the films, and due to their thick center thickness, the retardation caused by the birefringence of the lens material in the one-and-a-half round trip light path tends to be large. This retardation is a cause of flare and ghosting. An effective countermeasure is to manufacture these lenses from glass with low birefringence instead of resin, but using glass makes it difficult to create aspherical lenses, making aberration correction with a small number of lenses challenging.

[Regarding FIGS. 1 and 2]. The wide-field image display device T shown in FIG. 1 is used by the user looking in from the left side of FIG. 1 and includes, in order from the eye point EP side, an eyepiece optical system OP and an image display element DP. The wide-field image display device T may be provided for each of the user's right and left eyes, as shown in FIG. 2A, or it may be provided for only one of the user's eyes. The wide-field image display device T can be applied to, for example, a VR (Virtual Reality) HMD. It is preferable to use the eyepiece optical systems OP1 to OP7 according to the embodiments of the present invention which will be described later in the eyepiece optical system OP.

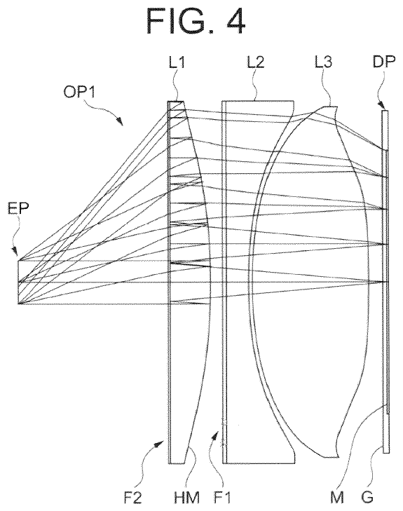

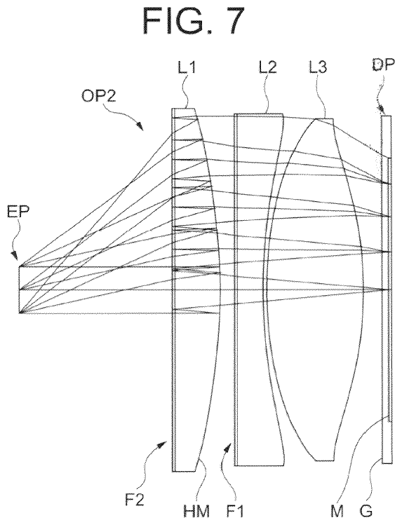

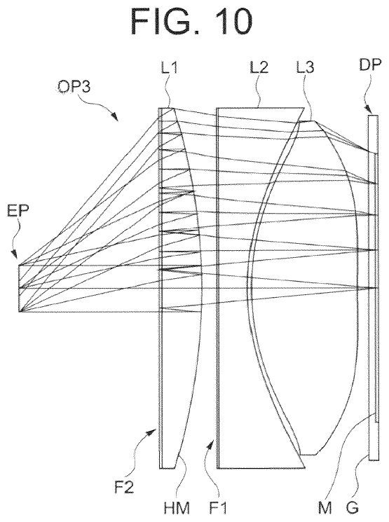

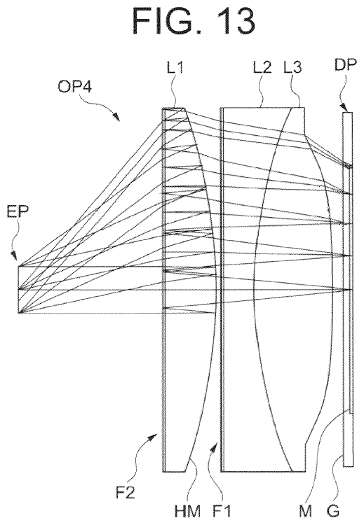

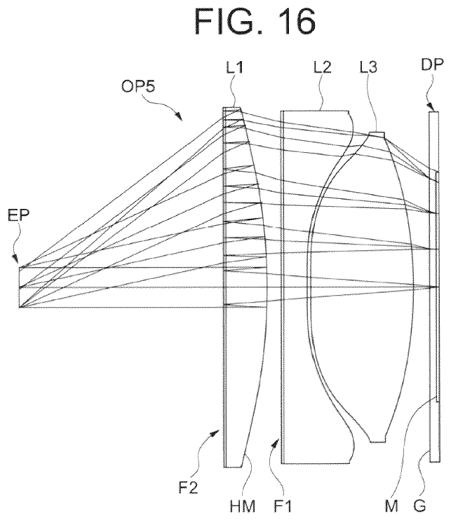

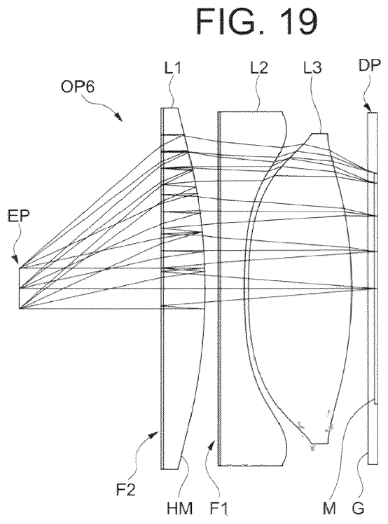

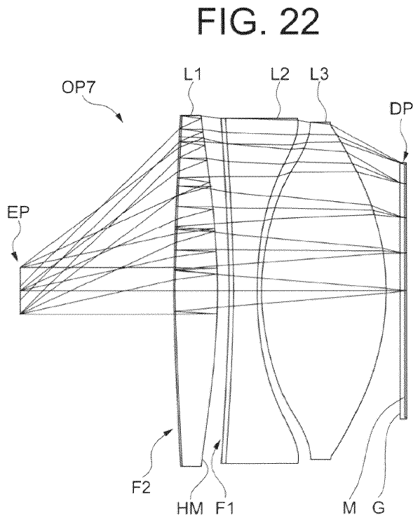

Hereinafter, embodiments of the eyepiece optical system according to the present invention will be described with reference to the accompanying drawings. The eyepiece optical systems OP1 to OP7 of embodiments 1 to 7 shown in FIGS. 4, 7, 10, 13, 16, 19, and 22 consist of, in order from the eye point EP side, a first lens L1 with a plano-convex or biconvex shape having positive refractive power with a convex surface facing the image display element DP side, a second lens L2 with a plano-concave or biconcave shape having negative refractive power with a concave surface facing the image display element DP side, and a third lens L3 with a biconvex shape having positive refractive power with a convex surface facing the eye point EP side.

Note that in the eyepiece optical systems OP1 to OP6 according to embodiments 1 to 6, the lens surface on the eye point EP side of the first lens L1 and the lens surface on the eye point EP side of the second lens L2 are flat. In the eyepiece optical system OP7 according to embodiment 7, the lens surface on the eye point EP side of the first lens L1 and the lens surface on the eye point EP side of the second lens L2 are approximately flat. In the eyepiece optical system OP4 according to embodiment 4, the lens surface on the image display element DP side of the second lens L2 and the lens surface on the eye point EP side of the third lens L3 are bonded.

The first to third lenses L1 to L3 are all made of plastic.
The lens surface on the image display element DP side of the first lens L1, the lens surface on the image display element DP side of the second lens L2, the lens surface on the eye point EP side of the third lens L3, and the lens surface on the image display element DP side of the third lens L3 are aspherical.

On the lens surface on the eye point EP side of the second lens L2 (surface number 13 in the lens data described later), a first film F1 is laminated, which changes the polarization state of light traveling from the image display element DP side to the eye point EP side to the first polarization state, specifically circular polarization.

On the lens surface on the eye point EP side of the first lens L1 (surface numbers 4, 10), a second film F2 is laminated, which reflects light in the first polarization state traveling from the image display element DP side to the eye point EP side and changes it to the second polarization state, specifically circular polarization with a rotation direction opposite to that of the first polarization state, and transmits light in the second polarization state traveling from the image display element DP side to the eye point EP side. A half mirror HM is coated on the lens surface on the image display element DP side of the first lens L1 (surface numbers 4, 6).

The first film F1 (from surface number 12 to 13) is a laminated film having a quarter-wave plate and a linear polarizer in order from the eye point EP side, with the slow axis of the quarter-wave plate inclined at 45 degrees to the transmission axis of the linear polarizer when viewed from the eye point EP side. The first film F1 further includes a quarter-wave plate on the image display element DP side of the linear polarizer.

The second film F2 is a laminated film having a reflective polarizer (from surface number 2 to 3) and a quarter-wave plate (from surface numbers 3 to 4, 7 to 8, 9 to 10) in order from the eye point EP side, with the slow axis of the quarter-wave plate inclined at 45 degrees to the transmission axis of the reflective polarizer when viewed from the eye point EP side. The second film F2 further includes a linear polarizer (surface number 2) on the eye point EP side of the reflective polarizer, having a transmission axis parallel to the transmission axis of the reflective polarizer.

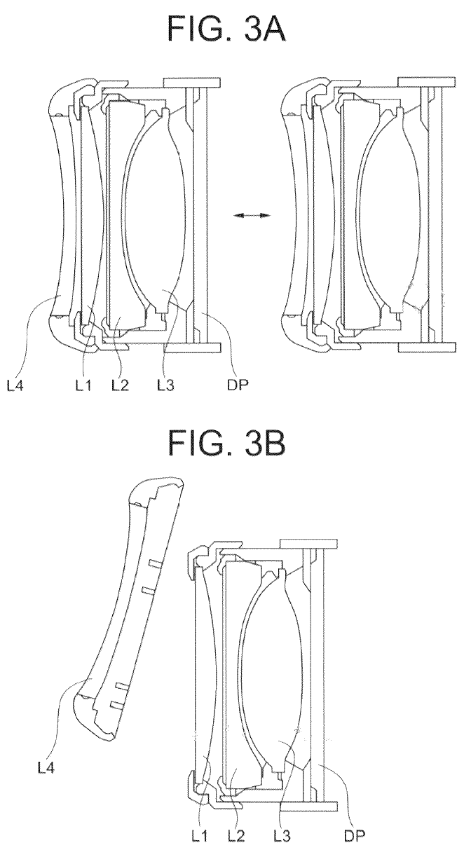

As shown in FIG. 3A, by moving the first lens L1 in the optical axis direction, the air gap between the first lens L1 and the second lens L2 can be varied for diopter adjustment. As shown in FIG. 3A, a fourth lens L4 for diopter correction is further provided on the eye point EP side of the first lens L1. As shown in FIG. 3B, the fourth lens LA can be inserted and removed between the eye point EP (not shown in FIG. 3B) and the first lens L1.

The image display element DP includes an image display surface M where images are displayed, a cover glass G that protects the image display surface M, and a display element substrate (not shown) that displays images on the image display surface M. The image display element DP can use a display panel with a large viewing angle, such as an OLED (Organic Light Emitting Diode) panel or a micro LED (Light Emitting Diode) panel, and an OLED panel is adopted in each embodiment.

The image light emitted from the image display element DP follows the normal optical path (including the folded optical path) exemplified in FIG. 1 and enters the user's eye (pupil). Specifically, as exemplified in FIG. 1, the image light emitted from the image display surface M of the image display element DP through the cover glass G becomes circularly polarized in the first polarization state by passing through the first film F1 of the second lens L2 after passing through the third lens L3 and the second lens L2. The image light in the first polarization state passes through the half mirror HM of the first lens L1. At this time, part of the image light in the first polarization state is reflected by the half mirror HM but becomes unnecessary light that does not contribute to the generation of the projected image.

The image light that has passed through the half mirror HM of the first lens L1 is reflected by the second film F2 of the first lens L1 and becomes circularly polarized in the second polarization state, which is opposite in rotation direction to the first polarization state, and is reflected by the half mirror HM of the first lens L1. At this time, part of the image light in the second polarization state passes through the half mirror HM but becomes unnecessary light that does not contribute to the generation of the projected image. Also, at this time, since the lens surface of the image display element DP of the first lens L1 coated with the half mirror HM acts as a concave mirror, the image light reflected by the half mirror HM passes through the second film F2 again and forms an enlarged image of the image displayed by the image display element DP in the air. This allows the user to see the enlarged image of the image displayed on the image display surface of the image display element DP.

### <Ray Tracing>

Each embodiment is shown using reverse tracing data.

### <Wavelength>

#Value (μm) Weight
1 0.525 1.0
2 0.550 0.5
3 0.500 0.5

The above is determined based on the following.
1) The color misalignment of red images and blue images relative to green images caused by the chromatic aberration of magnification in the eyepiece optical system can be canceled by adjusting the size of the red images and blue images input to the OLED (Organic Light Emitting Diode).
2) Visual sensitivity is higher for green than for blue and red. The most significant impact on resolution is the green MTF (Modulation Transfer Function) (absolute value of OTF (Optical Transfer Function)).
3) The typical green emission spectrum of an OLED has a peak at 0.525 μm with a half-width of 0.05 μm.

### <MTF>

MTF at a spatial frequency of 20 cycles/mm with a focus shift range of +0.5 mm
The wavelength is determined based on the following.

1) The maximum contrast sensitivity of the human eye is at 5 cycles/mm.
When converted to the image on the image display element,

1/{focal length of the eyepiece optical system×tan(⅕)}≈20 cycles/mm.

Note that the focal length of the eyepiece optical system in the embodiment is approximately 15 mm.

2) Since the human eye has the ability to adjust focus, the MTF considering this is calculated. Assuming the focus adjustment ability of the human eye is 4D (±2D), the amount of focus movement on the image display element side that the eye can adjust is calculated by the following formula.

$$Focus movement = \pm 2 D \times {\{ focal length of the eyepiece optical system ( mm ) \}}^{2} / 1000 \approx \pm 0.5 ( mm )$$

Therefore, if the MTF at 20 cycles/mm is good within a focus movement of +0.5 (mm), it can be said to have good resolution performance.

### <Aspherical Surface>

The [Aspherical Data] in the tables of embodiments 1 to 6 shows the aspherical coefficients when the shape of each aspherical surface is expressed by the following formula.

$$SAG ( h ) = ( {h}^{2} / R ) / [ 1 + {[ 1 - ( 1 + K ) \cdot {( h / R )}^{2} ]}^{1 / 2} ] + A \cdot {h}^{2} + B \cdot {h}^{4} + C \cdot {h}^{6} + D \cdot {h}^{8} + E \cdot {h}^{10} + F \cdot {h}^{12} + G \cdot {h}^{14} + H \cdot {h}^{16}$$

where,
   h (unit: mm): distance from the optical axis (height in the direction perpendicular to the optical axis)
   R (unit: mm): radius of curvature (paraxial radius of curvature), with the value being positive for lens surfaces with the center of curvature on the image display element side and negative for lens surfaces with the center of curvature on the eye point side
   SAG(h) (unit: mm): distance in the optical axis direction (sag amount) when the optical axis center of the aspherical surface at height h is the origin
   K: conic constant
   A-H: aspherical coefficients
Note that the conic constant K is 0 in each embodiment. “e-m” (m is an integer) indicates “×10^{-m}.” For example, “1.234e-05” indicates “1.234×10⁻⁵.”

In [Surface Data], the surface number indicates the order of the optical surfaces counted from the eye point side, the surface interval indicates the interval between the m-th surface (m is an integer) and the m+1-th surface, and the refractive index and Abbe number indicate the values for the d-line (wavelength 587.6 nm). “Object” indicates the projected image, “Stop” indicates the user's pupil, and “Image” indicates the display surface of the image display element. Note that “Infinity” indicates a plane, and the aspherical surface indicates the value of the paraxial radius of curvature.

### <Configuration and Surface Number>. Surface Number Surface on the Incident Side of Reverse Tracing Ray Remarks

Object Projected Image
Stop Eye Point
2 Polarizer of the Second Film
3 Reflective Surface of the Reflective Polarizer of the Second Film
4 Eye Point Side of the First Lens
5 Half Mirror on the Image Display Element Side of the First Lens Reflective Action
6 Image Display Element Side of the First Lens Aspherical Shape is the Same as Surface Number 5
7 Eye Point Side of the First Lens
8 Reflective Surface of the Reflective Polarizer of the Second Film Reflective Action
9 Reflective Polarizer of the Second Film
10 Eye Point Side of the First Lens
11 Image Display Element Side of the First Lens Aspherical Shape is the Same as
Surface Number 5
12 Eye Point Side of the First Film
13 Eye Point Side of the Second Lens
14 Image Display Element Side of the Second Lens In embodiment 4, both are spherical and bonded
15 Eye Point Side of the Third Lens
16 Image Display Element Side of the Third Lens
17 Virtual Surface
18 Eye Point Side of the Cover Glass of the Image Display Element
19 Virtual Surface
Image Display Surface of the Image Display Element

Note: The above description is common in the tables of Embodiments 1 to 6.

TABLE 1
Embodiment 1
[Surface Data]
Surface Number Radius of Curvature Surface Interval Refractive Index Abbe Number
Clear Diameter Surface Type
Object Infinity −1000 2606.4 Plane
Stop Infinity 13 4 Plane
2 Infinity 0.102 1.495000 50.0 30.3 Plane
3 Infinity 0.096 1.495500 50.0 32 Plane
4 Infinity 3.522629 1.501720 53.3 32 Plane
5 −51.14821 0 MIRROR 32 Aspherical
6 −51.14821 −3.522629 1.501720 53.3 32 Aspherical
7 Infinity −0.096 1.522000 50.0 32 Plane
8 Infinity 0 MIRROR 32 Plane
9 Infinity 0.096 1.522000 50.0 32 Plane
10 Infinity 3.522629 1.501720 53.3 32 Plane
11 −51.14821 0.946 32 Aspherical
12 Infinity 0.372 1.48800 50.0 32 Plane
13 Infinity 1.972503 1.649748 21.4 32 Plane
14 54.35213 0.36 32 Aspherical
15 52.9817 10.05183 1.535037 55.7 31 Aspherical
16 101.0285 1.57621 31 Aspherical
17 Infinity −0.366 23.1 Plane
18 Infinity 0.5 1.516330 64.1 30.1 Plane
19 Infinity 0 23.2 Plane
Image Infinity 23.2 Plane
[Aspherical Data]
Surface 5 Surface 6 Surface 11
Coefficient A 0 0 0
Coefficient B −2.1975957e−07 −2.1975957e−07 −2.1975957e−07
Coefficient C 1.4534145e−08 1.4534145e−08 1.4534145e−08
Coefficient D −3.6142064e−11 −3.6142064e−11 −3.6142064e−11
Coefficient E 8.8627063e−14 8.8627063e−14 8.8627063e−14
Coefficient F 0 0 0
Coefficient G 0 0 0
Coefficient H 0 0 0
Surface 14 Surface 15 Surface 16
Coefficient A 0 0 0
Coefficient B 6.0946095e−05 8.1780491e−05 −0.00032571242
Coefficient C −8.659336e−08 −4.4432112e−07 1.6079305e−06
Coefficient D 2.7513144e−10 3.1566089e−09 2.668748e−10
Coefficient E −6.2686291e−13 −4.3378254e−12 −1.0226796e−12
Coefficient F −5.4512715e−15 −4.1988321e−14 −2.9142482e−13
Coefficient G 0 1.2657221e−16 1.7390535e−15
Coefficient H 0 4.1572433e−20 −2.8549287e−18
[General Lens Data]
Aperture Surface: 1
Aperture Radius: 2
Effective Focal Length: 15.62819 (Image Space)
Back Focal Length: 0.2809868
Field Type: Angle (Degree)
Maximum Circular Field: 50
Principal Wavelength: 0.525 μm
[Conditional Expression Corresponding Values]
Distortion (%) −37.7
N1 1.5053
P0 0.06399
v2 21.4
v3 55.7
DD 2.58
LL 19.1
OL 31.22
SAG1 (h1) 0
SAG2 (h2) 0
FF 12.0
DN 32
DF 32
L1e Infinity
L1r −51.14821
L1d 1.1
ID 23.2
FOV 100
2 × N1/Lle 0
2 × N1/L1r 0.05886
(1) 0.8 × P0 < (2 × N1/L1e) + (2 × N1/L1r) < 1.2 × P0 → 0.051 < 0.059 < 0.076
(2) v2 < v3 → 21.4 < 55.7
(3) DD < OL/10 → 2.58 < 3.12
(4) | SAG1 (h1) | <0.05 × h1 → | SAG1 (h1) | = 0
(5) | SAG2 (h2) | <0.05 × h2 → | SAG2 (h2) | = 0
(6) 9 < FF < 15 → 9.0 < 12.0 < 15.0
(7) DN < 1.2 × DF → 32.0 < 38.4
(8) 44 < L1r < 65 → 44.0 < 51.1 < 65.0
(9) 0 < L1d < 5 → 0 < 1.1 < 5
(10) 1.45 < N1 < 1.55 → 1.45 < 1.5053 < 1.55
(11) ID < 0.9 × DF → 23.2 < 28.8
(12) 80 < FOV → 80 < 100
(13) 0.045 < (2 × N1/L1e) + (2 × N1/L1r) < 0.065 → 0.045 < 0.05886 < 0.065
(14) DIS (%) → −37.7

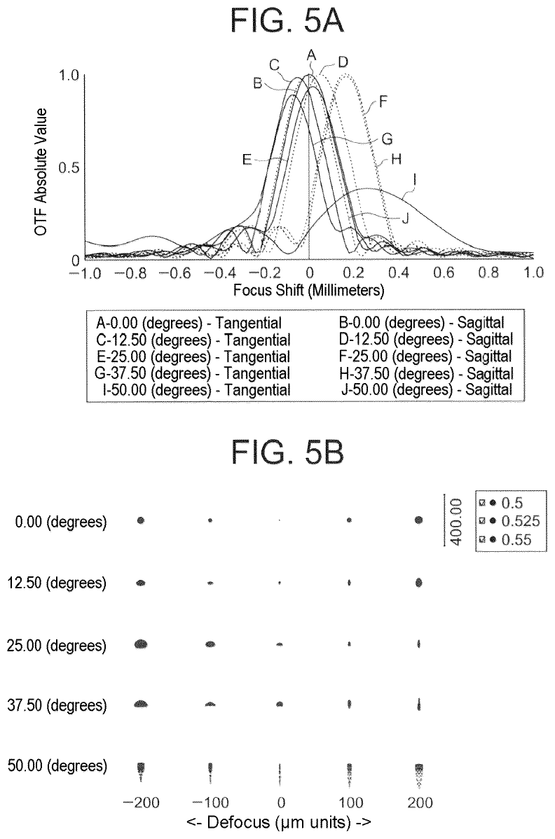

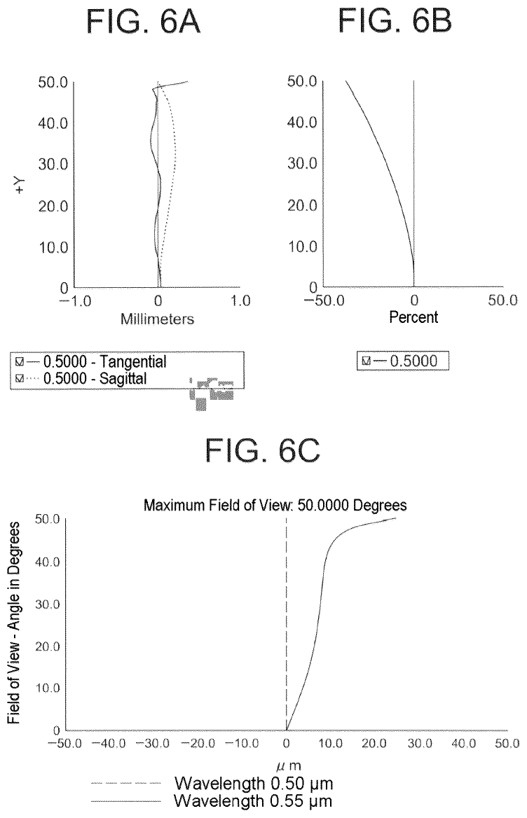

From FIGS. 5A to 6C, it can be seen that the eyepiece optical system OP1 of Embodiment 1 suppresses the occurrence of flare and ghosting, has well-corrected chromatic aberration, and has good imaging performance. Note that FIGS. 5A to 6C all show the lens performance of the eyepiece optical system OP1 of Embodiment 1 by reverse tracing. The horizontal axis “Focus Shift” in FIG. 5A indicates the amount of movement of the surface position for evaluating the OTF, with the reference being the position where the optimal focus image is obtained. The vertical axis in FIG. 5B indicates the field angle, and the horizontal axis indicates the focus position. FIG. 6C shows the difference in image height between light with a wavelength of 0.50 μm and light with a wavelength of 0.55 μm, i.e., chromatic aberration of magnification. The same applies to the figures of Embodiments 2 to 7 described later.

TABLE 2
Embodiment 2
[Surface Data]
Surface Number Radius of Curvature Surface Interval Refractive Index Abbe Number
Clear Diameter Surface Type
Object Infinity −1000 2383.5 Plane
Stop Infinity 13 4 Plane
2 Infinity 0.05 1.50000 50.0 28.9 Plane
3 Infinity 0.15 1.516330 64.1 31.4 Plane
4 Infinity 3.862767 1.501720 53.3 31.4 Plane
5 −51.67038 0 MIRROR 31.4 Aspherical
6 −51.67038 −3.862767 1.501720 53.3 31.4 Aspherical
7 Infinity −0.15 1.516330 64.1 31.4 Plane
8 Infinity 0 MIRROR 31.4 Plane
9 Infinity 0.15 1.516330 64.1 31.4 Plane
10 Infinity 3.862767 1.501720 53.3 31.4 Plane
11 −51.67038 1.2 31.4 Aspherical
12 Infinity 0.2 1.516330 64.1 30.4 Plane
13 Infinity 2.192285 1.635517 23.9 30.4 Plane
14 158.8413 0.3 30.0 Aspherical
15 53.12357 8.260357 1.535011 55.6 29.6 Aspherical
16 −42.86433 2.1296 29.6 Aspherical
17 Infinity −0.59 22.9 Plane
18 Infinity 0.88 1.516330 64.1 30.1 Plane
19 Infinity 0 22.9 Plane
Image Infinity 22.9 Plane
[Aspherical Data]
Surface 5 Surface 6 Surface 11
Coefficient A 0 0 0
Coefficient B 3.6078583e−06 3.6078583e−06 3.6078583e−06
Coefficient C −5.0717361e−09 −5.0717361e−09 −5.0717361e−09
Coefficient D 2.1583352e−11 2.1583352e−11 2.1583352e−11
Coefficient E 3.392819e−14 3.392819e−14 3.392819e−14
Coefficient F 0 0 0
Coefficient G 0 0 0
Coefficient H 0 0 0
Surface 14 Surface 15 Surface 16
Coefficient A 0.0079422874 0.0024042156 0
Coefficient B −6.2799901e−06 6.4270831e−05 −3.7211686e−05
Coefficient C 9.158541e−08 −3.6933251e−07 7.3140083e−08
Coefficient D −5.6175925e−10 1.0528551e−09 4.9659761e−10
Coefficient E 0 0 0
Coefficient F 0 0 0
Coefficient G 0 0 0
Coefficient H 0 0 0
[General Lens Data]
Aperture Surface: 1
Aperture Radius: 2
Effective Focal Length: 15.16928 (Image Space)
Back Focal Length: 0.2417917
Field Type: Angle (Degree)
Maximum Circular Field: 50
Principal Wavelength: 0.525 μm
[Conditional Expression Corresponding Values]
Distortion (%) −37.2
N1 1.5053
P0 0.06592
v2 23.9
v3 55.6
DD 3.98
LL 18.6
OL 30.04
SAG1 (h1) 0
SAG2 (h2) 0
FF 11.9
DN 31.4
DF 31.4
L1e Infinity
L1r −51.67
L1d 1.67
ID 22.8
FOV 100
2 × N1/L1e 0
2 × N1/L1r 0.05827
(1) 0.8 × P0 < (2 × N1/L1e) + (2 × N1/L1r) < 1.2 × P0 → 0.053 < 0.058 < 0.079
(2) v2 < v3 → 23.9 < 55.6
(4) | SAG1 (h1) | <0.05 × h1 → | SAG1 (h1) | = 0
(5) | SAG2 (h2) | <0.05 × h2 → | SAG2 (h2) | = 0
(6) 9 < FF < 15 → 9.0 < 11.9 < 15.0
(7) DN < 1.2 × DF → 31.4 < 37.68
(8) 44 < L1r < 65 → 44.0 < 51.7 < 65.0
(9) 0 < L1d < 5 → 0 < 1.7 < 5
(10) 1.45 < N1 < 1.55 → 1.45 < 1.5053 < 1.55
(11) ID < 0.9 × DF → 22.8 < 28.3
(12) 80 < FOV → 80 < 100
(13) 0.045 < (2 × N1/L1e) + (2 × N1/L1r) < 0.065 → 0.045 < 0.05827 < 0.065
(14) DIS (%) → −37.2

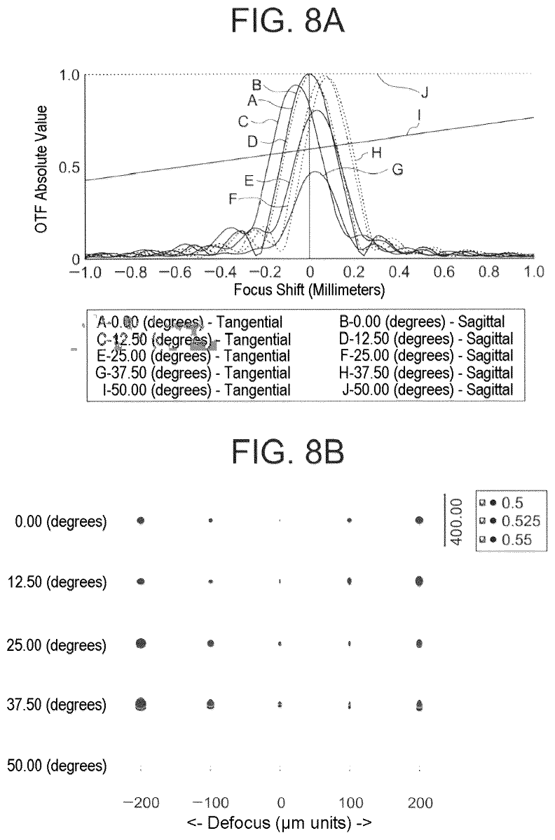

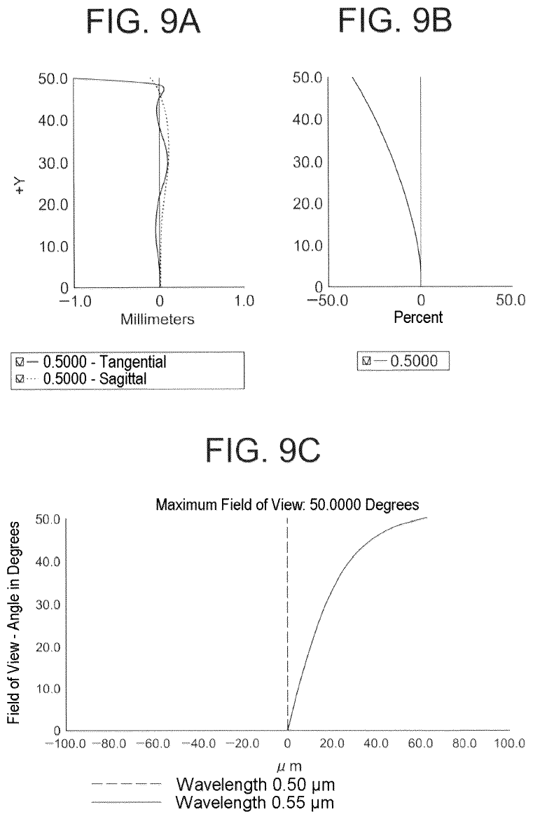

From FIGS. 8A to 9C, it can be seen that the eyepiece optical system OP2 of Embodiment 2 suppresses the occurrence of flare and ghosting, has well-corrected chromatic aberration, and possesses good imaging performance.

TABLE 3
Embodiment 3
[Surface Data]
Surface Number Radius of Curvature Surface Interval Refractive Index Abbe Number
Clear Diameter Surface Type
Object Infinity −1000 2383.5 Plane
Stop Infinity 12 4 Plane
2 Infinity 0.05 1.500000 50.0 29.8 Plane
3 Infinity 0.15 1.516330 64.1 31.4 Plane
4 Infinity 3.502138 1.501720 53.3 31.4 Plane
5 −49.33261 0 MIRROR 31.4 Aspherical
6 −49.33261 −3.502138 1.501720 53.3 31.4 Aspherical
7 Infinity −0.15 1.516330 64.1 31.4 Plane
8 Infinity 0 MIRROR 31.4 Plane
9 Infinity 0.15 1.516330 64.1 31.4 Plane
10 Infinity 3.502138 1.501720 53.3 31.4 Plane
11 −49.33261 1.2 31.4 Aspherical
12 Infinity 0.2 1.516330 64.1 30.2 Plane
13 Infinity 2.5 1.635517 23.9 30.1 Plane
14 34.4213 0.3 31.4 Aspherical
15 27.04904 9.053179 1.535011 55.6 28.9 Aspherical
16 50.75418 1.544122 29.1 Aspherical
17 Infinity −0.59 23.4 Plane
18 Infinity 0.877 1.516330 64.1 30.1 Plane
19 Infinity 0 23.5 Plane
Image Infinity 23.5 Plane
[Aspherical Data]
Surface 5 Surface 6 Surface 11
Coefficient A 0 0 0
Coefficient B 1.2569518e−06 1.2569518e−06 1.2569518e−06
Coefficient C 1.4032642e−08 1.4032642e−08 1.4032642e−08
Coefficient D −7.5966549e−11 −7.5966549e−11 −7.5966549e−11
Coefficient E 1.7229154e−13 1.7229154e−13 1.7229154e−13
Coefficient F 0 0 0
Coefficient G 0 0 0
Coefficient H 0 0 0
Surface 14 Surface 15 Surface 16
Coefficient A 0.0079422874 0.0024042156 0
Coefficient B −6.2799901e−06 6.4270831e−05 −0.00029168231
Coefficient C −3.1891239e−08 −3.6802516e−07 1.2988563e−06
Coefficient D 0 0 −2.4486596e−09
Coefficient E 0 0 0
Coefficient F 0 0 0
Coefficient G 0 0 0
Coefficient H 0 0 0
[General Lens Data]
Aperture Surface: 1
Aperture Radius: 2
Effective Focal Length: 15.7838 (Image Space)
Back Focal Length: 0.2610584
Field Type: Angle (Degree)
Maximum Circular Field: 50
Principal Wavelength: 0.525 μm
[Conditional Expression Corresponding Values]
Distortion (%) −37.5
N1 1.5053
P0 0.06336
v2 23.9
v3 55.6
DD 1.32
LL 18.8
OL 28.89
SAG1 (h1) 0
SAG2 (h2) 0
FF 11.5
DN 31.4
DF 31.4
L1e Infinity
L1r −49.333
L1d 1.1
ID 23.4
FOV 100
2 × N1/L1e 0
2 × N1/L1r 0.06103
(1) 0.8 × P0 < (2 × N1/L1e) + (2 × N1/L1r) < 1.2 × P0 → 0.051 < 0.061 < 0.076
(2) v2 < v3 → 23.9 < 55.6
(3) DD < OL/10 → 1.32 < 2.89
(4) | SAG1 (h1) | <0.05 × h1 → | SAG1 (h1) | = 0
(5) | SAG2 (h2) | <0.05 × h2 → | SAG2 (h2) | = 0
(6) 9 < FF < 15 → 9.0 < 11.5 < 15.0
(7) DN < 1.2 × DF → 31.4 < 37.68
(8) 44 < L1r < 65 → 44.0 < 49.3 < 65.0
(9) 0 < L1d < 5 → 0 < 1.1 < 5
(10) 1.45 < N1 < 1. 55 → 1.45 < 1.5053 < 1.55
(11) ID < 0.9 × DF → 23.4 < 28.3
(12) 80 < FOV → 80 < 100
(13) 0.045 < (2 × N1/L1e) + (2 × N1/L1r) < 0.065 → 0.045 < 0.06103 < 0.065
(14) DIS (%) → −37.5

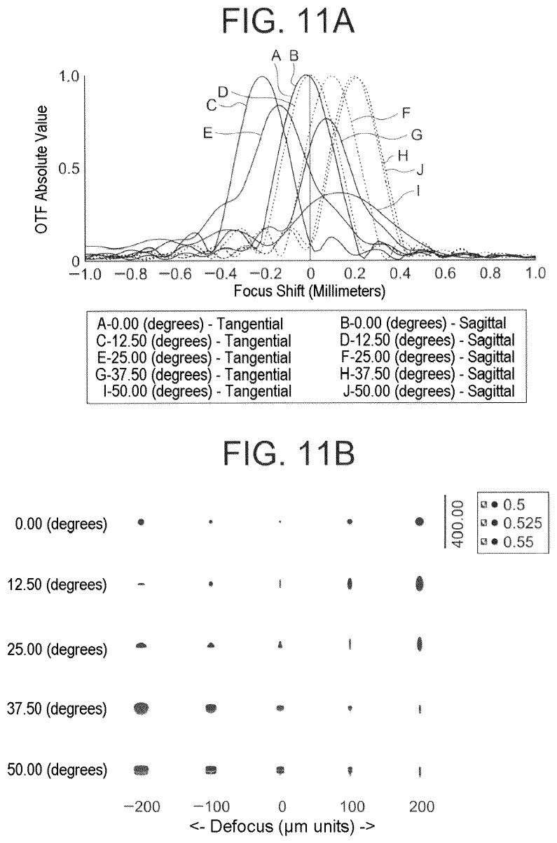

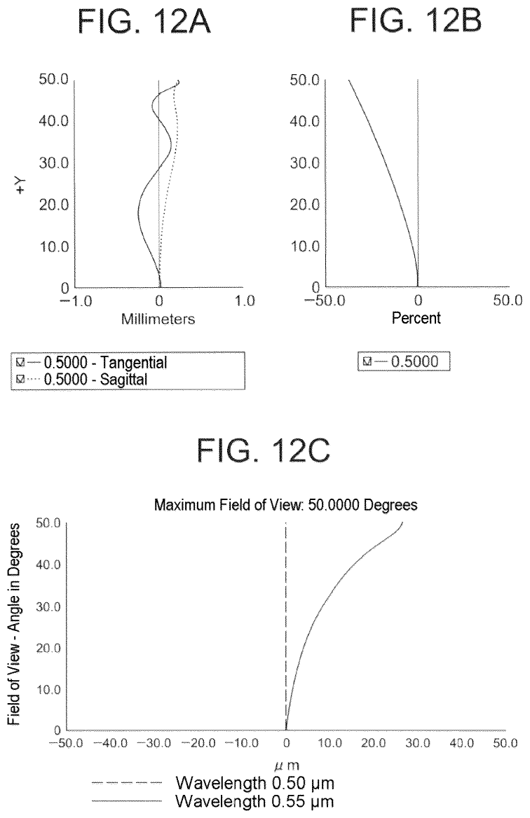

From FIGS. 11A to 12C, it can be seen that the eyepiece optical system OP3 of Embodiment 3 suppresses the occurrence of flare and ghosting, has well-corrected chromatic aberration, and possesses good imaging performance.

TABLE 4
Embodiment 4
[Surface Data]
Surface Number Radius of Curvature Surface Interval Refractive Index Abbe Number
Clear Diameter Surface Type
Object Infinity −1000 2383.5 Plane
Stop Infinity 12 4 Plane
2 Infinity 0.05 1.500000 50.0 28.9 Plane
3 Infinity 0.15 1.516330 64.1 31 Plane
4 Infinity 4.300516 1.501720 53.3 31 Plane
5 −43.74333 0 MIRROR 31 Aspherical
6 −43.74333 −4.300516 1.501720 53.3 31 Aspherical
7 Infinity −0.15 1.516330 64.1 31 Plane
8 Infinity 0 MIRROR 31 Plane
9 Infinity 0.15 1.516330 64.1 31 Plane
10 Infinity 4.300516 1.501720 53.3 31 Plane
11 −43.74333 0.3641883 31 Aspherical
12 Infinity 0.2 1.516330 64.1 28.8 Plane
13 Infinity 2.5 1.635517 23.9 28.7 Plane
14 38.60843 0 Bonded 31 Spherical
15 38.60843 6.600246 1.535011 55.6 31 Spherical
16 273.3491 −1.450254 26.5 Aspherical
17 Infinity −0.59 21.3 Plane
18 Infinity 0.877 1.516330 64.1 30.1 Plane
19 Infinity 0 21.3 Plane
Image Infinity 21.3 Plane
[Aspherical Data]
Surface 5 Surface 6 Surface 11
Coefficient A 0 0 0
Coefficient B 1.5006939e−07 1.5006939e−07 1.5006939e−07
Coefficient C 9.2611713e−09 9.2611713e−09 9.2611713e−09
Coefficient D 8.3742171e−12 8.3742171e−12 8.3742171e−12
Coefficient E 0 0 0
Coefficient F 0 0 0
Coefficient G 0 0 0
Coefficient H 0 0 0
Surface 16
Coefficient A 0
Coefficient B −0.00014589293
Coefficient C 3.6142322e−07
Coefficient D −1.032735e−10
Coefficient E 0
Coefficient F 0
Coefficient G 0
Coefficient H 0
[General Lens Data]
Aperture Surface: 1
Aperture Radius: 2
Effective Focal Length: 13.4741 (Image Space)
Back Focal Length: 0.1946818
Field Type: Angle (Degree)
Maximum Circular Field: 50
Principal Wavelength: 0.525 μm
[Conditional Expression Corresponding Values]
Distortion (%) −35.4
N1 1.5053
P0 0.07422
v2 23.9
v3 55.6
DD 0.00 (Bonded)
LL 15.9
OL 28.75
SAG1 (h1) 0
SAG2 (h2) 0
FF 9.3
DN 31
DF 31
L1e Infinity
L1r −43.743
L1d 1.6
ID 23.2
FOV 100
2 × N1/L1e 0
2 × N1/L1r 0.06882
(1) 0.8 × P0 < (2 × N1/L1e) + (2 × N1/L1r) < 1.2 × P0 → 0.059 < 0.069 < 0.089
(2) v2 < v3 → 23.9 < 55.6
(3 )DD < OL/10 → 0.00 < 2.87
(4) | SAG1 (h1) | <0.05 × h1 → | SAG1 (h1) | =0
(5) | SAG2 (h2) | <0.05 × h2 → | SAG2 (h2) | =0
(6) 9 < FF < 15 → 9.0 < 9.3 < 15.0
(7) DN < 1.2 × DF → 31.0 < 37.2
(8) 44 < L1r < 65 → 44.0 < 43.7 < 65.0
(9) 0 < L1d < 5 → 0 < 1.6 < 5
(10) 1.45 < N1 < 1.55 → 1.45 < 1.5053 < 1.55
(11) ID < 0.9 × DF → 23.2 < 27.9
(12) 80 < FOV → 80 < 100
(14) DIS (%) → −35.4

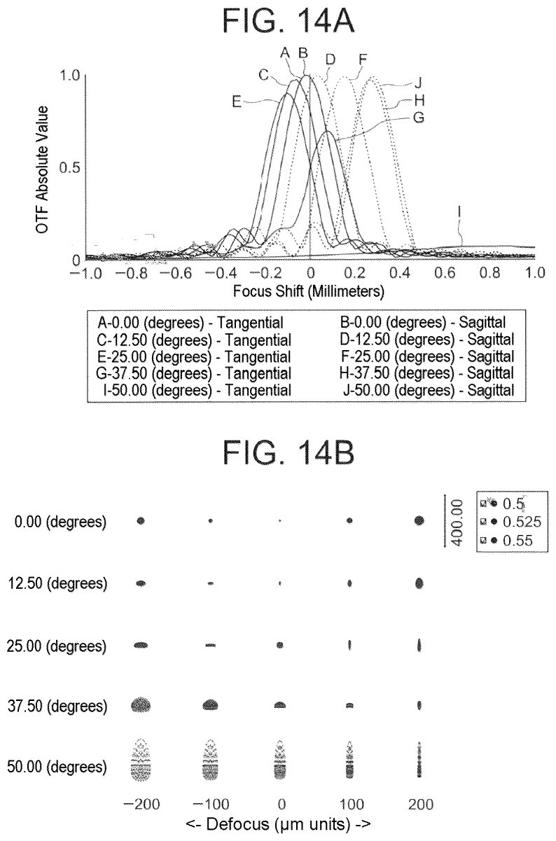

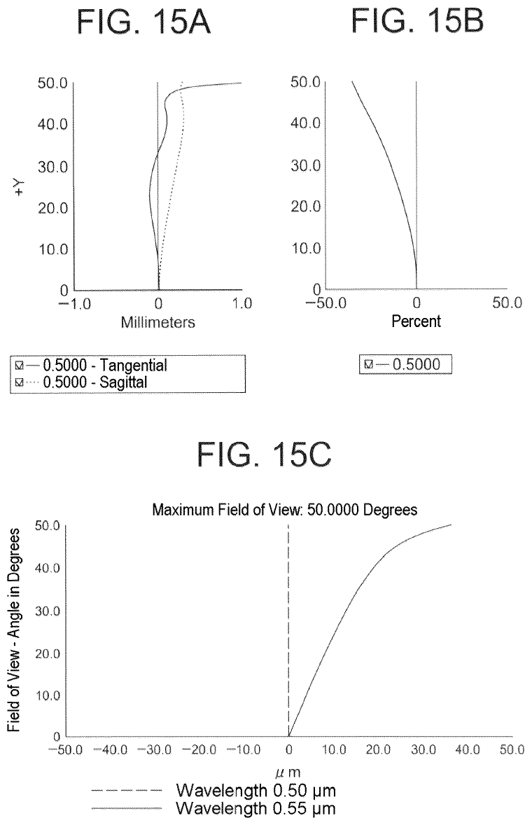

From FIGS. 14A to 15C, it can be seen that the eyepiece optical system OP4 of Embodiment 4 suppresses the occurrence of flare and ghosting, has well-corrected chromatic aberration, and possesses good imaging performance.

TABLE 5
Embodiment 5
[Surface Data]
Surface Number Radius of Curvature Surface Interval Refractive Index Abbe Number
Clear Diameter Surface Type
Object Infinity −1020 1804.8 Plane
Stop Infinity 20 4 Plane
2 Infinity 0.03 1.500000 50.0 33.1 Plane
3 Infinity 0.2 1.516330 64.1 35.6 Plane
4 Infinity 3.99822 1.501720 53.3 35.6 Plane
5 −57.34429 0 MIRROR 35.6 Aspherical
6 −57.34429 −3.99822 1.501720 53.3 35.6 Aspherical
7 Infinity −0.2 1.516330 64.1 35.6 Plane
8 Infinity 0 MIRROR 35.6 Plane
9 Infinity 0.2 1.516330 64.1 35.6 Plane
10 Infinity 3.99822 1.501720 53.3 35.6 Plane
11 −57.34429 1.38 35.6 Aspherical
12 Infinity 0.23 1.516330 64.1 34.9 Plane
13 Infinity 2.299439 1.649748 21.1 34.9 Plane
14 112.8706 0.345 34.5 Aspherical
15 212.0699 10.04112 1.535011 55.6 30.6 Aspherical
16 −59.92983 2.208072 29.5 Aspherical
17 Infinity −0.6785 22.8 Plane
18 Infinity 1.01 1.516330 64.1 34.6 Plane
19 Infinity 0 22.9 Plane
Image Infinity 22.9 Plane
[Aspherical Data]
Surface 5 Surface 6 Surface 11
Coefficient A 0 0 0
Coefficient B 6.1584E−07 6.1584E−07 6.1584E−07
Coefficient C 3.2772E−09 3.2772E−09 3.2772E−09
Coefficient D 2.3739E−12 2.3739E−12 2.3739E−12
Coefficient E 9.8923E−15 9.8923E−15 9.8923E−15
Coefficient F 0 0 0
Coefficient G 0 0 0
Coefficient H 0 0 0
Surface 14 Surface 15 Surface 16
Coefficient A 0 0 0
Coefficient B 1.1984E−04 1.7222E−04 −5.8007E−05
Coefficient C 2.0893E−07 −2.5103E−07 1.3813E−07
Coefficient D −2.0010E−09 1.2890E−09 1.7518E−10
Coefficient E −2.3223E−12 −9.8273E−13 −5.1363E−15
Coefficient F 1.1120E−14 −1.8072E−13 3.0281E−14
Coefficient G 0 1.2488E−15 −1.9826E−16
Coefficient H 0 −2.5024E−18 2.7048E−19
[General Lens Data]
Aperture Surface: 1
Aperture Radius: 2
Effective Focal Length: 17.17824 (Image Space)
Back Focal Length: 0.305454
Field Type: Angle (Degree)
Maximum Circular Field: 41.5
Principal Wavelength: 0.525 μm
[Conditional Expression Corresponding Values]
Distortion (%) −25.7
N1 1.5053
P0 0.05821
v2 21.1
v3 55.6
DD 1.63
LL 21.1
OL 30.64
SAG1 (h1) 0
SAG2 (h2) 0
FF 13.4
DN 35.6
DF 35.6
L1e Infinity
L1r −57.344
L1d 1.4
ID 22.8
FOV 83
2 × N1/L1e 0
2 × N1/L1r 0.05250
(1) 0.8 × P0 < (2 × N1/L1e) + (2 × N1/L1r) < 1.2 × P0 → 0.047 < 0.053 < 0.070
(2) v2 < v3 → 21.1 < 55.6
(3) DD < OL/10 → 1.63 < 3.06
(4) | SAG1 (h1) | <0.05 × h1 → | SAG1 (h1) | =0
(5) | SAG2 (h2) | <0.05 × h2 → | SAG2 (h2) | =0
(6) 9 < FF < 15 → 9.0 < 13.4 < 15.0
(7) DN < 1.2 × DF → 35.6 < 42.72
(8) 44 < L1r < 65 → 44.0 < 57.3 < 65.0
(9) 0 < L1d < 5 → 0 < 1.4 < 5
(10) 1.45 < N1 < 1.55 → 1.45 < 1.5053 < 1.55
(11) ID < 0.9 × DF → 22.8 < 28.8
(12) 80 < FOV → 80 < 83
(13) 0.045 < (2 × N1/L1e) + (2 × N1/L1r) < 0.065 → 0.045 < 0.05250 < 0.065
(14) DIS (%) → −25.7

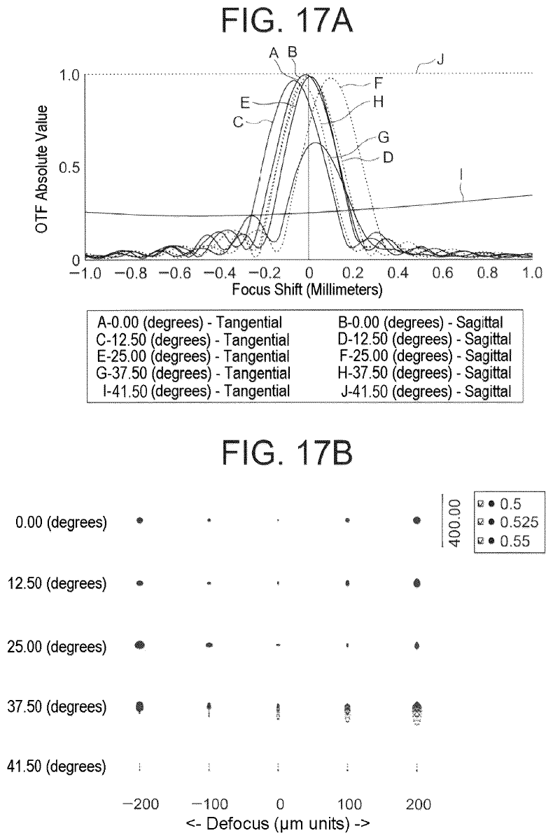

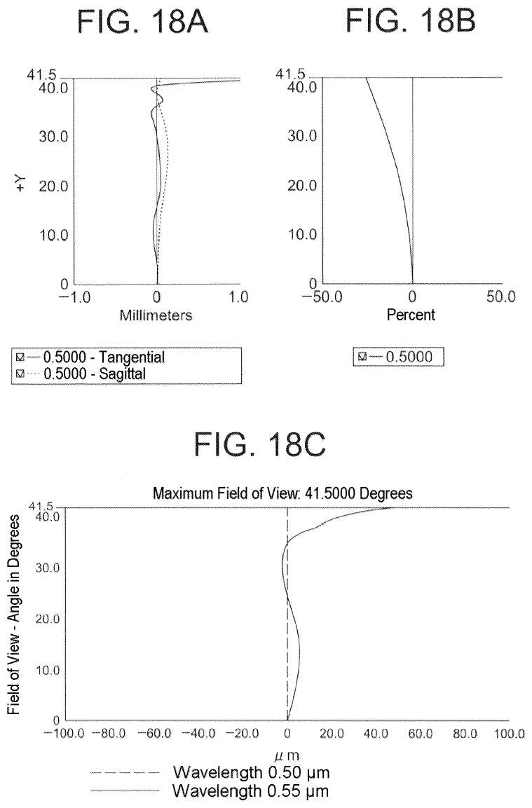

From FIGS. 17A to 18C, it can be seen that the eyepiece optical system OP5 of Embodiment 5 suppresses the occurrence of flare and ghosting, has well-corrected chromatic aberration, and possesses good imaging performance.

TABLE 6
Embodiment 6
[Surface Data]
Surface Number Radius of Curvature Surface Interval Refractive Index Abbe Number
Clear Diameter Surface Type
Object Infinity −1015 1795.9 Plane
Stop Infinity 15 4 Plane
2 Infinity 0.03 1.500000 50.0 35.6 Plane
3 Infinity 0.2 1.516330 64.1 35.6 Plane
4 Infinity 3.99145 1.501720 53.3 35.6 Plane
5 −58.59883 0 MIRROR 35.6 Aspherical
6 −58.59883 −3.99145 1.501720 53.3 35.6 Aspherical
7 Infinity −0.2 1.516330 64.1 35.6 Plane
8 Infinity 0 MIRROR 35.6 Plane
9 Infinity 0.2 1.516330 64.1 35.6 Plane
10 Infinity 3.99145 1.501720 53.3 35.6 Plane
11 −58.59883 1.38 35.6 Aspherical
12 Infinity 0.23 1.516330 64.1 34.9 Plane
13 Infinity 2.297588 1.649748 21.4 34.9 Plane
14 97.65185 0.345 34.5 Aspherical
15 69.83684 10.0882 1.535011 55.6 30.6 Aspherical
16 −44.81339 2.203781 29.5 Aspherical
17 Infinity −0.6785 22.8 Plane
18 Infinity 1.01 1.51633 64.1 34.6 Plane
19 Infinity 0 22.9 Plane
Image Infinity 22.9 Plane
[Aspherical Data]
Surface 5 Surface 6 Surface 11
Coefficient A 00 0
Coefficient B −3.9028662e−07 −3.9028662e−07 −3.9028662e−07
Coefficient C 6.6224292e−09 6.6224292e−09 6.6224292e−09
Coefficient D −4.3016211e−12 −4.3016211e−12 −4.3016211e−12
Coefficient E 1.0845346e−14 1.0845346e−14 1.0845346e−14
Coefficient F 0 0 0
Coefficient G 0 0 0
Coefficient H 0 0 0
Surface 14 Surface 15 Surface 16
Coefficient A 0 0 0
Coefficient B 0.000122977 0.00013595674 −2.2482122e−05
Coefficient C −2.0304732e−07 −2.5103126e−07 7.80396e−08
Coefficient D 1.0160901e−09 1.2889842e−09 1.751783e−10
Coefficient E −1.032591e−11 −9.8272573e−13 −5.1362802e−15
Coefficient F 1.8472608e−14 −1.1002164e−13 2.1048923e−14
Coefficient G 0 7.4743285e−16 −1.524474e−16
Coefficient H 0 −1.5020052e−18 2.6101181e−19
[General Lens Data]
Aperture Surface: 1
Aperture Radius: 2
Effective Focal Length: 16.7546 (Image Space)
Back Focal Length: 0.2913612
Field Type: Angle (Degree)
Maximum Circular Field: 41.5
Principal Wavelength: 0.525 μm
[Conditional Expression Corresponding Values]
Distortion (%) −23.3
N1 1.5053
P0 0.05969
v2 21.4
v3 55.6
DD 2.43
LL 21.1
OL 34.50
SAG1 (h1) 0
SAG2 (h2) 0
FF 13.7
DN 35.6
DF 35.6
L1e Infinity
L1r −58.599
L1d 1.4
ID 22.8
FOV 83
2 × N1/L1e 0
2 × N1/L1r 0.05138
(1) 0.8 × P0 < (2 × N1/L1e) + (2 × N1/L1r) < 1.2 × P0 → 0.048 < 0.051 < 0.071
(2) v2 < v3 → 21.4 < 55.6
(3) DD < OL/10 → 2.43 < 3.45
(4) | SAG1 (h1) | <0.05 × h1 → | SAG1 (h1) | =0
(5) | SAG2 (h2) | <0.05 × h2 → | SAG2 (h2) | =0
(6) 9 < FF < 15 → 9.0 < 13.7 < 15.0
(7) DN < 1.2 × DF → 34.9 < 42.72
(8) 44 < L1r < 65 → 44.0 < 58.6 < 65.0
(9) 0 < L1d < 5 → 0 < 1.4 < 5
(10) 1.45 < N1 < 1.55 → 1.45 < 1.5053 < 1.55
(11) ID < 0.9 × DF → 22.8 < 31.4
(12) 80 < FOV → 80 < 83
(13) 0.045 < (2 × N1/L1e) + (2 × N1/L1r) < 0.065 → 0.045 < 0.05138 < 0.065
(14) DIS (%) → −23.3

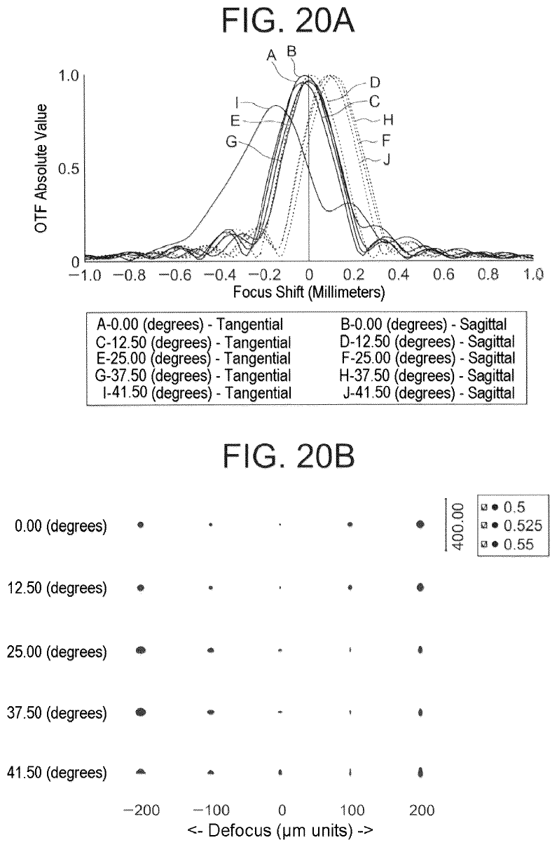

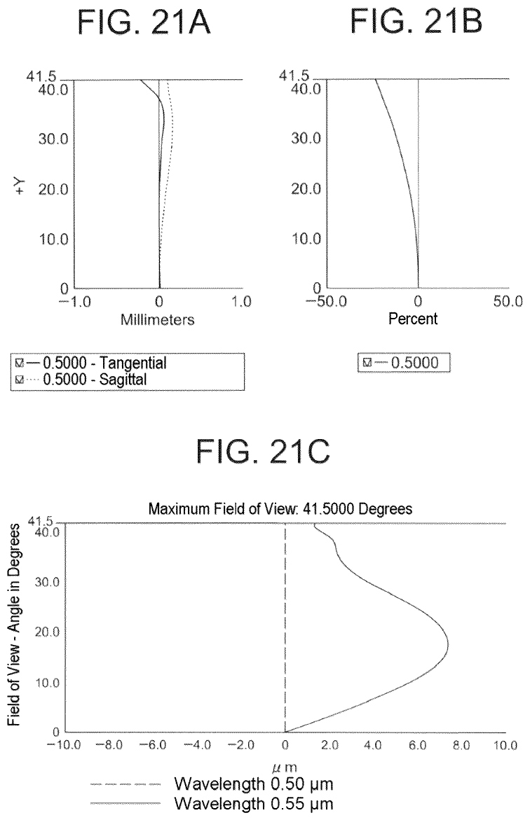

From FIGS. 20A to 21C, it can be seen that the eyepiece optical system OP6 of Embodiment 6 suppresses the occurrence of flare and ghosting, has well-corrected chromatic aberration, and possesses good imaging performance.

TABLE 7
Embodiment 7
[Surface Data]
Surface Number Radius of Curvature Surface Interval Refractive Index Abbe Number
Clear Diameter Surface Type
Object Infinity −1000 2000 Plane
Stop Infinity 13 4 Plane
2 170.000 0.102 1.495 50.00 30.2 Spherical
3 170.000 0.096 1.495 50.00 30.2 Spherical
4 170.000 3.549 1.502 53.38 30.2 Spherical
5 −71.662 0 MIRROR 30.2 Aspherical
6 −71.662 −3.549 1.502 53.38 30.2 Aspherical
7 170.000 −0.096 1.522 50.00 30.2 Spherical
8 170.000 0 MIRROR 30.2 Spherical
9 170.000 0.096 1.522 50.00 30.2 Spherical
10 170.000 3.549 1.502 53.38 30.2 Spherical
11 −71.662 0.946 30.2 Aspherical
12 −170.000 0.372 1.488 50.00 29.7 Spherical
13 −170.000 2.000 1.650 21.45 29.7 Spherical
14 34.485 0.36 29.7 Aspherical
15 22.577 10.601 1.535 55.71 28.9 Aspherical
16 −21.931 1.499 28.6 Aspherical
17 Infinity −0.366 21.6 Plane
18 Infinity 0.5 1.516 64.14 22.0 Plane
19 Infinity 0 22.0 Plane
Image Infinity 21.7 Plane
[Aspherical Data]
Surface 5 Surface 6 Surface 11
Coefficient A 0 0 0
Coefficient B −5.53317E−07 −5.53317E−07 −5.53317E−07
Coefficient C 1.07362E−08 1.07362E−08 1.07362E−08
Coefficient D −2.06829E−11 −2.06829E−11 −2.06829E−11
Coefficient E 1.44399E−13 1.44399E−13 1.44399E−13
Coefficient F 0 0 0
Coefficient G 0 0 0
Coefficient H 0 0 0
Surface 14 Surface 15 Surface 16
Coefficient A 000.00000E+00
Coefficient B 8.00155E−06 −3.18718E−05 −3.34124E−05
Coefficient C 6.12469E−07 8.00256E−07 7.53304E−07
Coefficient D −1.82365E−09 −4.14924E−09 −7.15162E−09
Coefficient E −1.35772E−11 −1.24837E−12 5.95870E−11
Coefficient F 3.88396E−14 4.50636E−14 −3.73176E−13
Coefficient G 0 −2.55230E−16 1.29261E−15
Coefficient H 0 5.87608E−19 −1.73294E−18
[General Lens Data]
Aperture Surface: 1
Aperture Radius: 2
Effective Focal Length: 14.68561 (Image Space)
Back Focal Length: 0.254127
Field Type: Angle (Degree)
Maximum Circular Field: 45
Principal Wavelength: 0.525 μm
[Conditional Expression Corresponding Values]
Distortion (%) −26.4
N1 1.502
P0 0.068094
v2 21.5
v3 55.7
DD 1.08
OL 29.3
SAG1 (h1) 0.67
SAG2 (h2) 0.65
FF 11.7
DN 29.7
DF 30.2
L1e 170
L1r 71.662
L1d 1.4
ID 21.7
FOV 90
2 × N1/L1e 0.0177
2 × N1/L1r 0.042
(1) 0.8 × P0 < (2 × N1/L1e) + (2 × N1/L1r) < 1.2 × P0 → 0.054 < 0.060 < 0.081
(2) v2 < v3 → 21.5 < 55.7
(3) DD < OL/10 → 1.08 < 2.93
(4) | SAG1 (h1) | <0.05 × h1 → 0.67 < 0.76 (h = 15.1)
(5) | SAG2 (h2) | <0.05 × h2 → 0.65 < 0.72 (h = 14.8)
(6) 9 < FF < 15 → 9.0 < 11.7 < 15.0
(7) DN < 1.2 × DF → 29.7 < 36.2
(9) 0 < L1d < 5 → 0 < 1.4 < 5
(10) 1.45 < N1 < 1.55 → 1.45 < 1.502 < 1.55
(11) ID < 0.9 × DF → 21.7 < 27.2
(12) 80 < FOV → 80 < 90
(13) 0.045 < (2 × N1/L1e) + (2 × N1/L1r) < 0.065 → 0.045 < 0.060 < 0.065
(14) DIS (%) → −26.4%

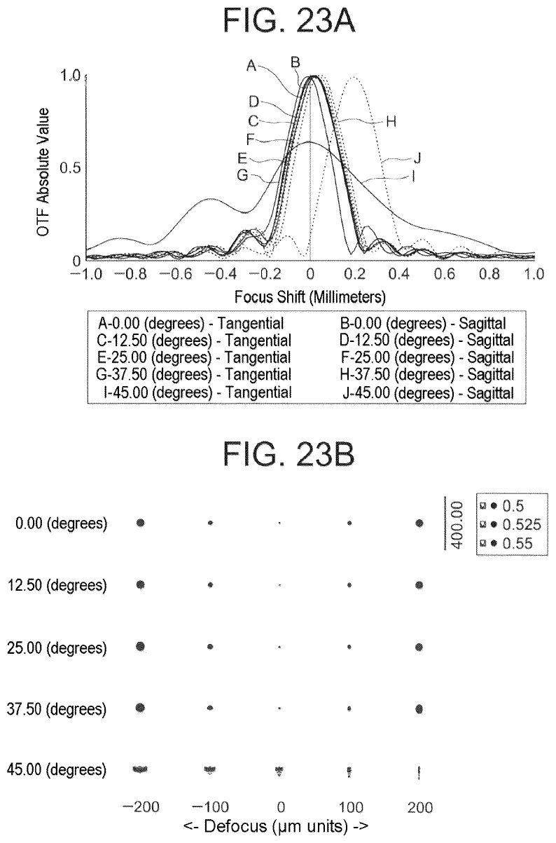

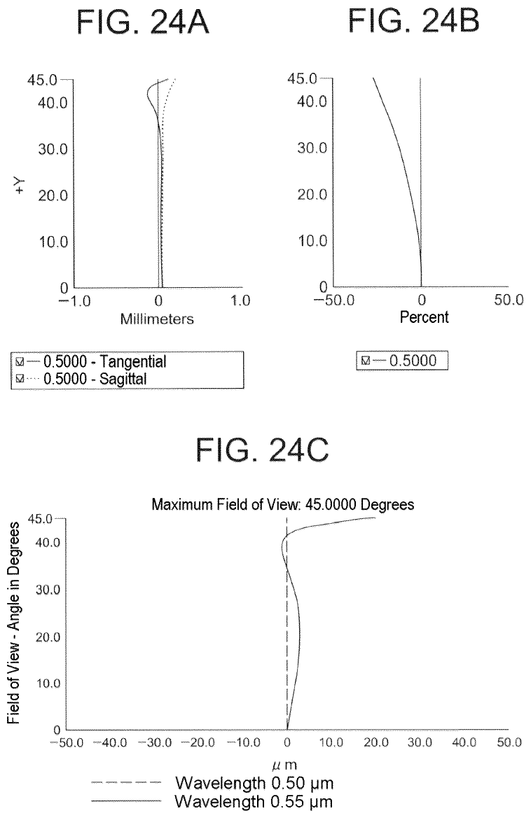

From FIGS. 23A to 24C, it can be seen that the eyepiece optical system OP7 of Embodiment 7 suppresses the occurrence of flare and ghosting, has well-corrected chromatic aberration, and possesses good imaging performance.

According to each of the above embodiments, it is possible to realize an eyepiece optical system that suppresses the occurrence of flare, ghosting, and chromatic aberration. Furthermore, by using the eyepiece optical systems OP1 to OP7 according to each of the above embodiments in the wide-field image display device T shown in FIGS. 1 and 2A, it is possible to realize a wide-field image display device that suppresses the occurrence of flare, ghosting, and chromatic aberration.

### EXPLANATION OF REFERENCE NUMERALS

OP1-OP7 Eyepiece Optical System
L1 First Lens
L2 Second Lens
L3 Third Lens
L4 Fourth Lens
F1 First Film
F2 Second Film
HM Half Mirror
EP Eye Point
DP Image Display Element
M Image Display Surface of the Image Display Element
G Cover Glass of the Image Display Element.

What is claimed is:

1. An eyepiece optical system disposed between an eye point of a wide-field image display device and an image display element, comprising:
a first lens with a convex lens surface on the image display element side and positive refractive power, a second lens with a concave lens surface on the image display element side, and a third lens with a convex lens surface on the eye point side, arranged in order from the eye point side;
a first film which is adhered to the lens surface on the eye point side of the second lens and changes the polarization state of light traveling from the image display element side to the eye point side to a first polarization state, and
a second film which is adhered to the lens surface on the eye point side of the first lens, reflects light in the first polarization state traveling from the image display element side to the eye point side and changes said light to a second polarization state, and transmits light in the second polarization state traveling from the image display element side to the eye point side, wherein a half mirror is coated on the lens surface on the image display element side of the first lens, and the following conditional expressions are satisfied,
$$0.8 \times P 0 < ( 2 \times N 1 / L 1 e ) + ( 2 \times N 1 / L 1 r ) < 1.2 \times P 0 ,$$
$$v 2 < v 3 ,$$
where,
P0: refractive power of the eyepiece optical system (unit: mm⁻¹),
N1: refractive index of the first lens for light with a wavelength of 525 nm,
L1e: radius of curvature of the lens surface on the eye point side of the first lens (unit: mm),
L1r: radius of curvature of the lens surface on the image display element side of the first lens (unit: mm),
ν2: Abbe number for the d-line (wavelength 587.6 nm) of the second lens,
ν3: Abbe number for the d-line (wavelength 587.6 nm) of the third lens.

2. The eyepiece optical system of claim 1, wherein the second lens has negative refractive power, and the third lens has positive refractive power.

3. The eyepiece optical system of claim 1, wherein the lens surface on the image display element side of the second lens and the lens surface on the eye point side of the third lens satisfy the following conditional expression across the entire lens surface,
$$DD < OL / 10$$
where,
DD: maximum value of the interval measured in the optical axis direction between the lens surface on the image display element side of the second lens and the lens surface on the eye point side of the third lens (unit: mm),
OL: aperture diameter of the lens surface on the image display element side of the second lens (unit: mm).

4. The eyepiece optical system of claim 1, wherein the lens surface on the image display element side of the second lens and the lens surface on the eye point side of the third lens are bonded.

5. The eyepiece optical system of claim 1, wherein the following conditional expressions are satisfied.
$$\vert SAG 1 ( h 1 ) \vert < 0. 05 \times h 1$$
$$\vert SAG 2 ( h 2 ) \vert < 0. 05 \times h 2$$
where,
SAG1(h1): sag amount at the position of height h1 (unit: mm) within the aperture diameter from the optical axis of the lens surface on the eye point side of the first lens (unit: mm),
SAG2(h2): sag amount at the position of height h2 (unit: mm) within the aperture diameter from the optical axis of the lens surface on the eye point side of the second lens (unit: mm).

6. The eyepiece optical system of claim 1, wherein the rear focal position of the first lens is further to the eye point side than the second film, and the following conditional expression is satisfied,
$$9 < FF < 15$$
where,
FF: distance from the second film to the rear focal position of the first lens (unit: mm).

7. The eyepiece optical system of claim 1, wherein the following conditional expressions are satisfied,
$$DN < 1.2 \times DF$$
where,
DF: aperture diameter on the eye point side of the second film (unit: mm),
DN: aperture diameter of the lens surface with the largest aperture diameter among the lens surfaces other than the lens surface on the eye point side of the first lens (unit: mm).

8. The eyepiece optical system of claim 1, wherein the following conditional expressions are satisfied,
$$44 < L 1 r < 65$$
$$0 < L 1 d < 5$$
$$1.45 < N 1 < 1.55$$
where,
L1d: thickness in the optical axis direction of the edge portion of the first lens (unit: mm).

9. The eyepiece optical system of claim 1, wherein the following conditional expressions are satisfied,
$$ID < 0.9 \times DF$$
where,
ID: dimension of the image displayed on the image display surface of the image display element, projected by the eyepiece optical system when the eyepiece optical system enlarges and projects the image (in whole or in part) displayed on the image display surface of the image display element into the air (unit: mm),
DF: aperture diameter on the eye point side of the second film (unit: mm).

10. The eyepiece optical system of claim 1, wherein the lens surface on the image display element side of the third lens is an aspherical surface with the center protruding outward in the optical axis direction beyond the edge.

11. The eyepiece optical system of claim 1, wherein the following conditional expressions are satisfied,
$$80 < FOV$$
$$0.045 < ( 2 \times N 1 / L 1 e ) + ( 2 \times N 1 / L 1 r ) < 0.0 \; 65$$
$$DIS < - 20$$
where,
FOV: field of view angle of the image display of the eyepiece optical system (unit: degrees),
DIS: distortion in reverse tracing (unit: %).

12. The eyepiece optical system of claim 1, wherein diopter adjustment is performed by varying the air gap between the first lens and the second lens.

13. The eyepiece optical system of claim 1, further comprising a fourth lens for diopter correction on the eye point side of the first lens.

14. The eyepiece optical system of claim 13, wherein the fourth lens is insertable and removable between the eye point and the first lens.

15. The eyepiece optical system of claim 1, wherein the first lens is made of plastic, and the lens surface on the image display element side of the first lens is aspherical.

16. The eyepiece optical system of claim 1, wherein the second lens and the third lens are made of plastic, and the lens surface on the image display element side of the second lens, the lens surface on the eye point side of the third lens, and the lens surface on the image display element side of the third lens are aspherical.

17. The eyepiece optical system of claim 1, wherein the first polarization state is circular polarization, and the second polarization state is circular polarization with a rotation direction opposite to that of the first polarization state.

18. The eyepiece optical system of claim 17, wherein the second film is a laminated film having a reflective polarizer and a quarter-wave plate in order from the eye point side, with the slow axis of the quarter-wave plate inclined at 45 degrees to the transmission axis of the reflective polarizer when viewed from the eye point side, and
the first film is a laminated film having a quarter-wave plate and a linear polarizer in order from the eye point side, with the slow axis of the quarter-wave plate inclined at 45 degrees to the transmission axis of the linear polarizer when viewed from the eye point side.

19. The eyepiece optical system of claim 18, wherein the second film further includes a polarizer on the eye point side of the reflective polarizer, having a transmission axis parallel to the transmission axis of the reflective polarizer.

20. The eyepiece optical system of claim 18, wherein the first film further includes a quarter-wave plate on the image display element side of the linear polarizer.

21. The eyepiece optical system of claim 1, wherein the lens surface on the image display element side of the second lens has a large curvature in the negative direction in the region up to 80% of the aperture relative to the center curvature, or the lens surface on the eye point side of the third lens has a large curvature in the positive direction in the region up to 80% of the aperture relative to the center curvature.

22. The eyepiece optical system of claim 21, wherein the lens surface on the image display element side of the second lens has a curvature at the periphery that increases in the direction where the concave becomes stronger in the region up to 80% of the aperture relative to the center curvature, and the lens surface on the eye point side of the third lens has a curvature at the periphery that increases in the direction where the convex becomes stronger in the region up to 80% of the aperture relative to the center curvature.

23. A wide-field image display device comprising the eyepiece optical system according to any one of claims 1 to 22.

24. The wide-field image display device of claim 23, wherein the third lens is a plastic lens manufactured by injection molding, is provided with a D-cut surface on the outer periphery, and is further provided with a gate for injection molding on the D-cut surface, and the third lens is arranged in the barrel so that the D-cut surface faces the user's nose side.
